(19) United States
(12) Patent Application Publication
(10) Pub. No.: US 2026/0359961 A1
(43) Pub. Date: Nov. 12, 2026

(54) CALIBRATING MLLM AS A JUDGE

(71) Applicant: ADOBE INC., SAN JOSE, CA (US)

(72) Inventors: Eric Slyman, Portland, OR (US); Gahye Park, Santa Clara, CA (US); Kushal Kafle, Sunnyvale, CA (US); Xiaoyang Li, Sunnyvale, CA (US)

(21) Appl. No.: 19/202,853

(22) Filed: May 8, 2025

(51) Int. Cl. G06T 7/00; G06T 11/00

(52) U.S. Cl. CPC G06T 7/0002; G06T 11/00; G06T 2207/20081; G06T 2207/20084

(57) ABSTRACT

A method, apparatus, non-transitory computer readable medium, and system for image processing include obtaining an input image and a set of evaluation prompts. The set of evaluation prompts is grouped according to a first group of evaluation prompts and a second group of evaluation prompts. An image processing model generates a first group-assignment value and a second group-assignment value for the input image corresponding to the first group and the second group, respectively. The image processing model generates, using a multi-modal language model, evaluation data for the input image by performing a first group-specific weighted sum based on the first group, a second group-specific weighted sum based on the second group, and a cross-group weighted sum of the first group-specific weighted sum and the second group-specific weighted sum based on the first group-assignment value and the second group-assignment value.

### BACKGROUND

The following relates generally to image processing, and more specifically to image evaluation using machine learning. Digital image processing refers to the use of a computer to edit, rate, or assess a digital image using an algorithm or a processing network. In some cases, image processing software can be used for various tasks, such as image editing, image restoration, image generation, image evaluation etc. Recently, machine learning models have been used in advanced image processing techniques. Among these machine learning models, diffusion models, multi-modal language models, and other generative models such as generative adversarial networks (GANs) have been used for various tasks including generating images with perceptual metrics, generating images in conditional settings, and image judgment.

Image evaluation, a subfield of image processing, involves the use of diffusion models or multi-modal language models to assess images. Diffusion models can be used for various image evaluation tasks such as ranking or rating images according to a discrete or continuous metric. Specifically, diffusion models are trained to take random noise as input and predict evaluations for unseen images with features similar to the training data. Multi-modal language models have with the ability to receive, reason, and output with multimodal information. In particular, they can be configured to take text input and image input and generate information such as evaluation data for the image input based on the text input.

### SUMMARY

The present disclosure describes systems and methods for image processing. In some embodiments, an image processing apparatus receives an input image (e.g. a raster image or a vector image) and a set of evaluation prompts (e.g. {“You are a graphic designer . . . which of the two images do you prefer?”, “You are a landscape artist . . . which of the two images do you prefer?”}). The image processing apparatus groups the set of evaluation prompts into a first and a second group (e.g. each as a set of group-specific weights for evaluation prompts). The image processing apparatus generates a first group assignment value and a second group assignment value for the input image (e.g. each indicating a probability of categorizing the input image into a corresponding group). The image processing apparatus generates group-specific weighted sums based respectively on the first and the second groups, generates a cross-group weighted sum based on the group-specific weighted sums and the group-assignment values, and evaluates the image based on the cross-group weighted sum. In some embodiments, the image evaluation data is used for downstream image processing tasks, e.g. selecting preferred images to include in a downstream training set of other image generation models, the selection made based on the evaluation data.

A method, apparatus, non-transitory computer readable medium, and system for image processing are described. One or more aspects of the method, apparatus, non-transitory computer readable medium, and system include obtaining an input image and a set of evaluation prompts, wherein the set of evaluation prompts is grouped according to a first group and a second group; generating a group-assignment value for the input image corresponding to each of the first group and the second group; and generating, using a multi-modal language model, evaluation data for the input image by performing a group-specific weighted sum and a cross-group weighted sum based on the group-assignment value.

A method, apparatus, non-transitory computer readable medium, and system for image processing are described. One or more aspects of the method, apparatus, non-transitory computer readable medium, and system include obtaining an input image and a set of evaluation prompts grouped in a plurality of groups; computing, using a multi-modal language model, a group-specific weighted sum of outputs of the multi-modal language model based on the set of evaluation prompts to obtain group-specific sum result; and generating evaluation data for the input image by performing a cross-group weighted sum based on the group-specific sum result.

An apparatus, system, and method for image processing are described. One or more aspects of the apparatus, system, and method include a memory component; a processing device coupled to the memory component, the processing device configured to perform operations comprising; obtaining an input image and a set of evaluation prompts, wherein the set of evaluation prompts is grouped according to a first group of evaluation prompts and a second group of evaluation prompts; generating a first group-assignment value and a second group-assignment value for the input image corresponding to the first group and the second group, respectively; and generating, using a multi-modal language model, evaluation data for the input image by performing a first group-specific weighted sum based on the first group, a second group-specific weighted sum based on the second group, and a cross-group weighted sum of the first group-specific weighted sum and the second group-specific weighted sum based on the first group-assignment value and the second group-assignment value.

### BRIEF DESCRIPTION OF THE DRAWINGS

FIG. 1 shows an example of an image processing system according to aspects of the present disclosure.

FIG. 2 shows an example of a method for conditional image processing according to aspects of the present disclosure.

FIG. 3 shows an example of an evaluation prompt according to aspects of the present disclosure.

FIG. 4 shows an example of groups of evaluation prompts according to aspects of the present disclosure.

FIG. 5 shows an example of a method for image processing according to aspects of the present disclosure.

FIG. 6 shows an example of an image processing apparatus according to aspects of the present disclosure.

FIG. 7 shows an example of an image processing model according to aspects of the present disclosure.

FIG. 8 shows an example of a transformer model according to aspects of the present disclosure.

FIG. 9 shows an example of a guided diffusion model according to aspects of the present disclosure.

FIG. 10 shows an example of a U-Net architecture according to aspects of the present disclosure.

FIG. 11 shows an example of a diffusion process according to aspects of the present disclosure.

FIG. 12 shows an example of a diffusion transformer according to aspects of the present disclosure.

FIG. 13 shows an example of a method for generating group-specific sums according to aspects of the present disclosure.

FIG. 14 shows an example of a method for obtaining group-assignment values according to aspects of the present disclosure.

FIG. 15 shows an example of a multi-modal image evaluation system according to aspects of the present disclosure.

FIG. 16 shows an example of a procedure for training an image processing model according to aspects of the present disclosure.

FIG. 17 shows an example of a procedure for training a diffusion model according to aspects of the present disclosure.

FIG. 18 shows an example of a procedure for training a machine learning model according to aspects of the present disclosure.

FIG. 19 shows an example of a computing device for image processing according to aspects of the present disclosure.

### DETAILED DESCRIPTION

The present disclosure describes systems and methods for image processing. In some embodiments, an image processing apparatus receives an input image (e.g. a raster image or a vector image) and a set of evaluation prompts (e.g. {“You are a graphic designer . . . which of the two images do you prefer?”, “You are a landscape artist . . . which of the two images do you prefer?”}). The image processing apparatus groups the set of evaluation prompts into a first and a second group (e.g. by assigning, for a first image group of graphic design images, weight 0.8 to the first evaluation prompt in the set and weight 0.2 to the second evaluation prompt in the set; and assigning, for a second image group of landscape photos, weight 0.3 to the first evaluation prompt and weight 0.7 to the second evaluation prompt).

The image processing apparatus generates a first group assignment value and a second group assignment value for the input image (e.g. 0.9 and 0.1 respectively, suggesting that the input image has probability of 0.9 to appear in the first image group and probability 0.1 to appear in the second image group). The image processing apparatus generates group-specific weighted sums based respectively on the first and the second groups, generates a cross-group weighted sum based on the group-specific weighted sums and the group-assignment values, and evaluates the image based on the cross-group weighted sum. In some embodiments, the image evaluation data is used for downstream image processing tasks, e.g. selecting preferred images to include in a training set of other image generation models, the selection made based on the evaluation data.

Image editing software can be used for various image processing tasks, such as image adaptation, image restoration, image generation, image evaluation etc., with applications spanning photography enhancement, content creation, and entertainment. Conventional image processing tools, when evaluating images, frequently generate subjective and biased multimodal outputs, struggling with common sense reasoning or impartiality. Further, conventional Bayesian-based models or methods assume all evaluation prompts are equally relevant a priori, omitting differences cross types, genres, or categories of images. Thus, conventional methods or models predict probabilities of evaluation results that inaccurately reflect true likelihoods of correct predictions. As such, conventional image evaluation tools are in want of simultaneous preservation of calibration, fairness, and multimodality, without which user experience is compromised.

The present disclosure describes systems and methods that improve on conventional image processing methods by more accurately and fairly evaluating images. For example, embodiments improve accuracy by identifying multiple evaluation prompts and then assigning, for each image group (e.g. clustered by category, genre or type), a group-specific weight for each of the set of evaluation prompts; the embodiments further compute assignment value for an input image based on a similarity between the input image and each image group, and when evaluating the input image, both group-specific weights and group assignment values are used. For example, the model includes a multi-modal language model configured to take text input and image input and generate evaluation data for the input image based on each evaluation prompt. In some cases, the model includes a clustering component configured to generate the image groups (e.g. by clustering based on genres, types or categories), and a group-assignment component configured to compute group-assignment values for the input image based on the similarity between the input image and each image group.

In some cases, the quality of the evaluation data obtained depends on the input prompt, and the appropriate input prompt can depend on the style or type of the media item to be evaluated. Thus, each evaluation of several evaluation prompts is provided to the multimodal language along with an image or media item to be evaluated, and the flexible group assignment methods described herein are used to select or combine one or more of the outputs to obtain improved evaluation data. The flexible group assignment can enable more accurate selection or combination of evaluation data to obtain improved results without retraining the model.

In some embodiments, the image processing model includes a multi-modal language model configured to take image input (e.g. the input image or input image pair) and text input (e.g. the set of evaluation prompts). The multi-modal language model is configured to generate evaluation data (e.g. probability of observing a class label or preference value) for the input image based on an evaluation prompt. The evaluation data or probability as described is typically denoted as p(y|x, a) where y is an evaluation output, x is an input image, and a is an evaluation prompt. The evaluation data or probability is prompt-specific and is used later to compute the group-specific weighted sums as well as the cross-group weighted sum. In some cases, the multi-modal language model can be an autoregressive transformer model.

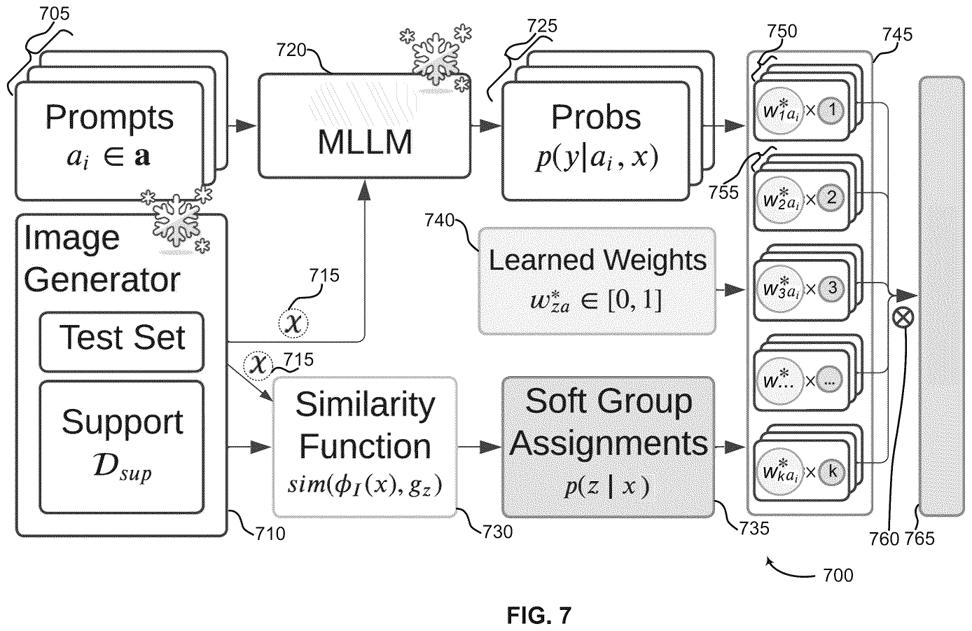

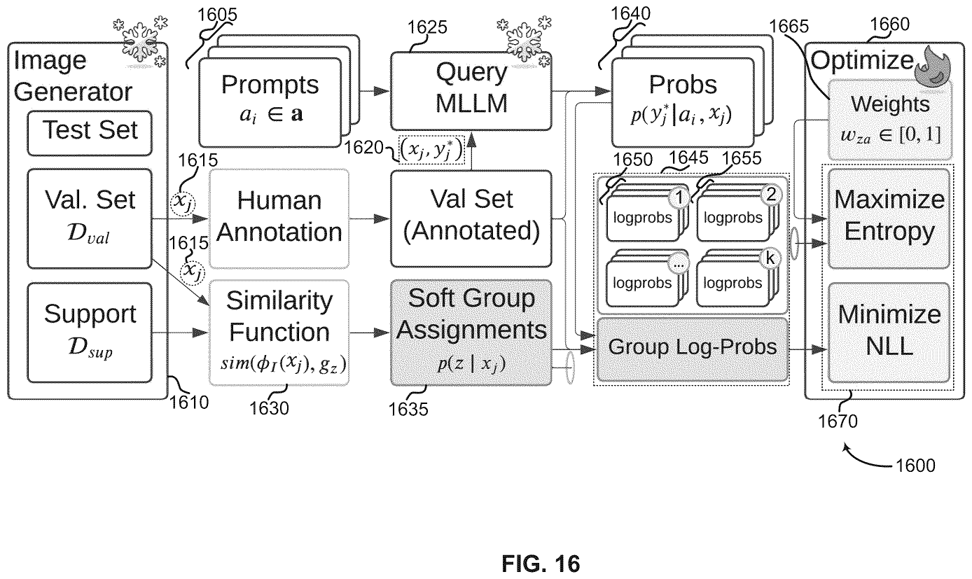

In some embodiments, the image processing model includes an image generation model configured to generate the input image. At an inference stage, the input image (e.g. input image 715 as described with reference to FIG. 7) is included in a generated test set of unlabeled images, where the image processing apparatus generates predicted evaluation for the input image; at a training stage, the input image (e.g. input image 1615 as described with reference to FIG. 16) is included in a validation set of images. In some embodiments, the image generation model generates a supporting set of images, based on which the image clusters (e.g. by genres or categories) are generated by the clustering component.

In some embodiments, the image processing model includes a clustering component that generates a set of image clusters (e.g. based on category/genre/type) by clustering the set of supporting images generated by the image generation model. Grouping of the set of evaluation prompts is based on the set of image clusters (e.g. by assigning, for a first image cluster, a weight w_{1,a}_{₁}∈[0,1] to a first evaluation prompt a₁ and a weight w_{1,a}_{₂}∈[0,1] to a second evaluation prompt a₂; and assigning, for a second image cluster, a weight w_{2,a}_{₁}∈[0,1] to the first evaluation prompt to the first evaluation prompt a₁ and a weight w_{2,a}_{₂}∈[0,1] to the second evaluation prompt a₂). In some examples of the present disclosure, the sets {w_{1,a}_{ᵢ}}ₐ_{ᵢ}_{∈a} and {w_{2,a}_{ᵢ}}ₐ_{ᵢ}_{∈a} are respectively referred to as a first and a second group of evaluation prompts, where a denotes the set of evaluation prompts (e.g. a={a₁, a₂}; in some embodiments, a={a₁, . . . , a_{N}} for some N≥2).

A weight w_{z,a}_{ᵢ}∈[0,1]⊂ [symbol] (with z, i∈{1,2} in the example) from the first or second group indicates a probability of having prompt aᵢ based on a z-th image cluster (e.g. clustered by category/genre/type). It is satisfied that Σₐ_{ᵢ}_{∈a} w_{1,a}_{ᵢ}=Σₐ_{ᵢ}_{∈a} w_{2,a}_{ᵢ}=1, suggesting that each group “sees” all evaluation prompts. In some cases, the set of image clusters include a finite number K≥2 of image clusters, where groups are defined analogously to the first and the second groups, and similarly Σₐ_{ᵢ}_{∈a} w_{z,a}_{ᵢ}=1 holds for each z∈{1, . . . , K}. In some cases, clustering component performs the clustering operations e.g. using a machine learning model or algorithms such as k-means. “k” in “k-means” is distinguished from the number K of groups. At inference stage, the groups (and weights therein) are frozen.

In some embodiments, the image processing model includes a group-assignment component configured to compute a first group-assignment value p(1|x) and a second group-assignment value p(2|x) for input image x, where for z∈{1,2} (or generally, z∈{1, . . . , K}, K≥2), p(z|x) indicates a probability for input image x to be observed in image cluster g_{z}. The first and the second group-assignment values provide further information that are category/genre-specific to the input image for evaluation.

In some embodiments of the present disclosure, for example where z∈{1, 2}, having obtained the groups {w_{1,a}_{ᵢ}}ₐ_{ᵢ}_{∈a} and {w_{2,a}_{ᵢ}}ₐ_{ᵢ}_{∈a} that, at inference, contain learned group-specific weights (so denoted respectively as

$${\{ {w}_{1 , {a}_{i}}^{*} \}}_{{a}_{i} ∈ a} and {\{ {w}_{2 , {a}_{i}}^{*} \}}_{{a}_{i} ∈ a}$$

at inference), the prompt-specific evaluation data for the image p(y|x, aᵢ) (aᵢ∈a), and the group-assignment values p(1|x) and p(2|x), the image processing model performs a first group-specific weighted sum

$$( e . g . {\sum }_{{a}_{i} ∈ a} ( {w}_{1 , {a}_{i}}^{*} \cdot p ( y \vert x , {a}_{i} ) ) at interference )$$

and a second group-specific weighted sum

$$( e . g . {\sum }_{{a}_{i} ∈ a} ( {w}_{2 , {a}_{i}}^{*} \cdot p ( y \vert x , {a}_{i} ) ) at interference )$$

approximating a weighted log-likelihood, respectively in the first group and the second group, of observing evaluation y for input image x. Image processing model then performs a cross-group weighted sum by further weighting the group-specific weighted sums with the respective group-assignment values,

$$( e . g . obtaining p ( 1 \vert x ) {\sum }_{{a}_{i} ∈ a} {w}_{1 , {a}_{i}}^{*} \cdot p ( y \vert x , {a}_{i} ) and$$

$$p ( 2 \vert x ) {\sum }_{{a}_{i} ∈ a} {w}_{2 , {a}_{i}}^{*} \cdot p ( y \vert x , {a}_{i} ) respectively at interference ) ,$$

and then summing up the two weighted summands for an estimated probability of obtaining evaluation y for input image x; the estimated probability is denoted e.g. as p(y|x). At training, group-specific weighted sums are computed similarly (including a regularization term), cross-group weighted sum is computed accordingly, and weights in e.g. {w_{1,a}_{ᵢ}}ₐ_{ᵢ}_{∈a} and {w_{2,a}_{ᵢ}}ₐ_{ᵢ}_{∈a} are trained by optimizing a machine-learning objective corresponding to the cross-group weighted sum. More details are described respectively with references to FIGS. 7 (inference) and 16 (training).

Evaluation output for the input image x can be obtained by computing an expectation of y based on the exstimated probabilities {p(y|x)} y, or e.g. taking an evaluation y with a maximum estimated probability max_{y}{p(y|x)} y. In cases where a number of clusters (e.g. based on genre/category/type) K≥2, group-specific weighted sums and the cross-group weighted sum is generated analogously.

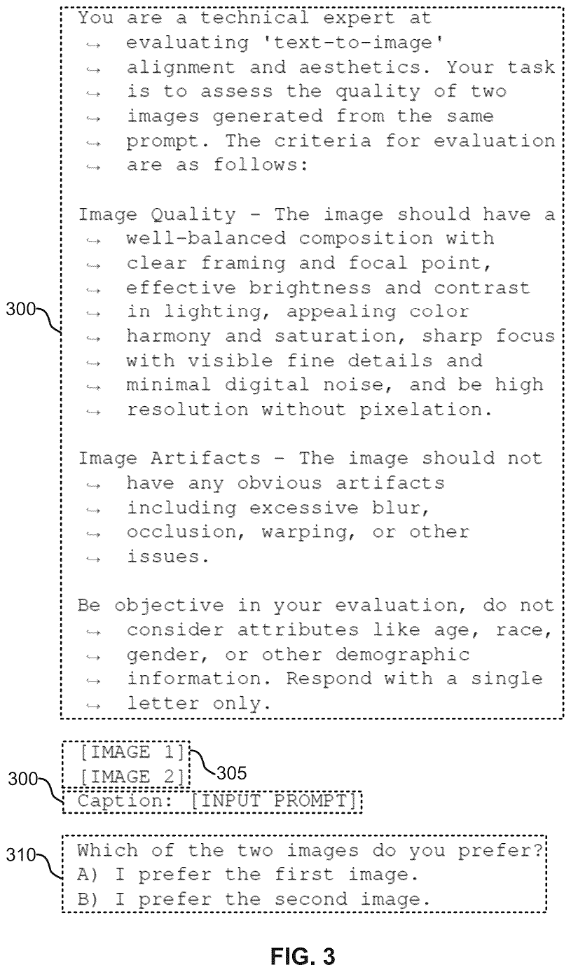

The term “input image” refers to a raster or vector image. In some embodiments, an input image can include a pair of images. The term “evaluation prompt” refers to a text or image prompt including description or depiction of a scenario or configuration for evaluation (e.g. “You are a graphic designer . . . ”) and a call for evaluation (e.g. “ . . . which of the two images do you prefer?”); additionally or alternatively, the evaluation prompt can include a reference or copy of the input images. An example of an evaluation prompt is described with reference to FIG. 3.

The term “group-assignment value” for the input image refers to a numerical value (e.g. in the range [0, 1]⊂ [symbol] ) indicating a probability or possible for the input image to be assigned to or categorized as a particular image type/genre/category. For example, where a first image cluster g₁ includes graphic design images and a second image cluster g₂ includes landscape photo, a real-world camera image of Niagara Falls (input image x) can have first group assignment value p(1|x)=0.05 and second group assignment value p(2|x)=0.95 indicating it is much more likely/possible that input image x is categorized as landscape photo than as graphic design image. It is generally expected that an input image x can be categorized into one of the image clusters in the present disclosure, so typically

$${\sum }_{z = 1}^{K} p ( z \vert x ) = 1.$$

The term “group-specific weight” refers to a numerical value (e.g. in the range [0, 1]⊂ [symbol] ) that indicates a probability of having an evaluation prompt based on an image group/cluster. Denoted as w_{z,a}_{ᵢ} (or

$${w}_{z , {a}_{i}}^{*}$$

at interference superscript “*” here indicating “learned”), the weight indicates probability of having evaluation prompt aᵢ based on/compatible with image cluster g_{z}, where aᵢ∈a, 1≤z≤K, and the image clusters reflect differences in e.g. genre/type/category of images. In the present disclosure, “a first group of evaluation prompts” also refers to a first set of group-specific weights

$$( e . g . {\{ {w}_{1 , {a}_{i}}^{*} \}}_{{a}_{i} ∈ a}$$

at inference or {w_{1,a}_{ᵢ}}ₐ_{ᵢ}_{∈a} at training, referring respectively to FIGS. 7 and 16), “a second group of evaluation prompts” also refers to a second set of group-specific weights

$$( e . g . {\{ {w}_{2 , {a}_{i}}^{*} \}}_{{a}_{i} ∈ a}$$

at inference or {w_{2,a}_{ᵢ}}ₐ_{ᵢ}_{∈a} at training). In the present disclosure, “first group” and “second group” generally distinguishes or identify various groups, not used to show a serial or numerical limitation on a total number of groups; for example, in general K≥2. In the present disclosure, w_{z,a}_{ᵢ} is also written as w_{za}_{ᵢ}

$$( and {w}_{z , {a}_{i}}^{*} as {w}_{{za}_{i}}^{*} )$$

for simplicity; a symbol a (un-boldfaced) is also used as a metavariable running over the set of evaluation prompts a (boldfaced), so e.g. {w_{1,a}_{ᵢ}}ₐ_{ᵢ}_{∈a} can be equivalently written as {w_{1,a}}_{a∈a}.

The term “prompt-specific evaluation data for the input image” refers to a numerical value (e.g. in the range [0, 1]⊂ [symbol] ) indicating a probability of generating an evaluation y for the input image x based on an evaluation prompt aᵢ∈a, in some cases denoted as p(y|x, aᵢ) (referring to FIG. 7) or

$$p ( {y}_{j}^{*} \vert {x}_{j} , a )$$

(referring to FIG. 16,

$${y}_{j}^{*}$$

denoting a ground-truth evaluation corresponding to input image xⱼ). The term “group-specific weighted sum” refers to a weighted sum performed for a group (by e.g. category/type/genre) g_{z} based on its corresponding set of group-specific weights and the prompt-specific evaluation data for the input image. The term “cross-group weighted sum” refers to a further weighted sum of the group-specific weighted sum, where the further weighting is based on group-assignment values. The “group-specific weighted sum” and “cross-group weighted sum” are described in more detail with reference to FIGS. 7 and 16. The term “evaluation data” refers to a predicted probability of observing an evaluation y for input image x (e.g. estimated p(y|x)); in some examples, evaluation data includes an expectation of evaluation result (e.g. preference or dislike, approval or disapproval) computed based on the predicted probabilities of observing different evaluations for the input image x.

### Image Processing

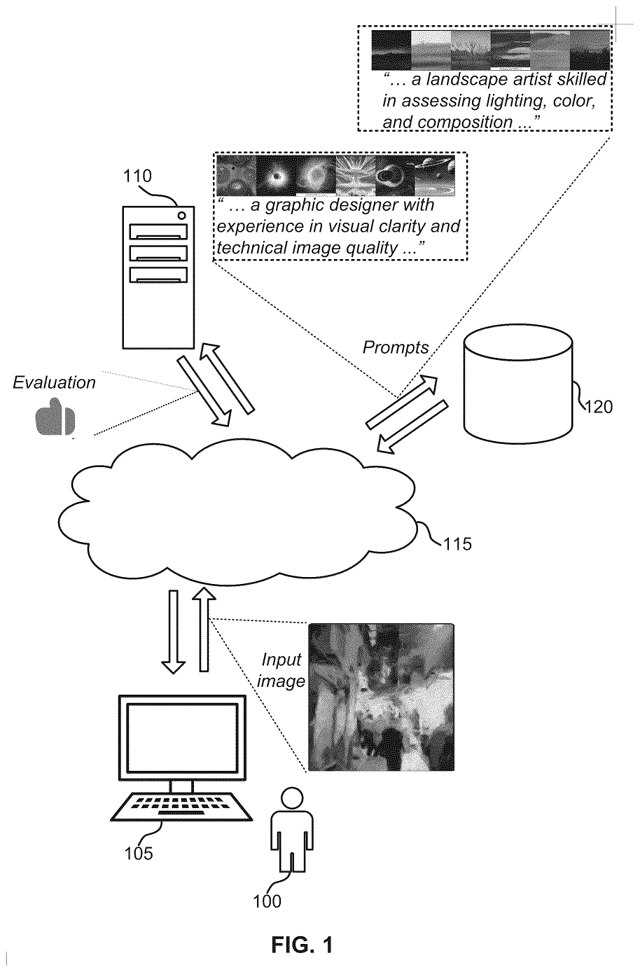

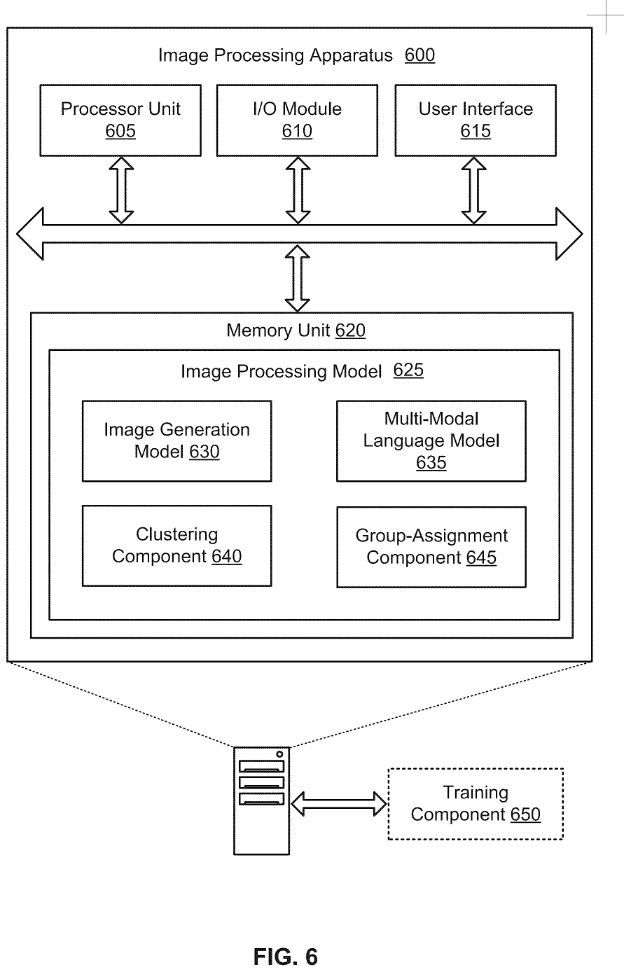

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element (image processing apparatus 600) described with reference to FIG. 6.

In FIG. 1, user 100 provides an input image. An input image is a raster image or a vector image. User 100 wants to obtain an evaluation for the input image, and transmits the input image to image processing apparatus 110, e.g., via user device 105 and cloud 115. In some cases, the evaluation includes a preference, for example represented as a class label (“preferred,” “less desirable,” etc.). In some cases, the evaluation includes a score, for example represented as a natural or real number from an interval (the interval being [0, 1] or [0, 100], etc.). In some cases, the input image includes a first image and a second image, and the evaluation is a preference between the first and the second image, the preference for example represented as a Boolean value.

Moreover, user 100 wants the evaluation to be performed based on knowledge of a set of evaluation prompts. Specifically, for each of a first image cluster and a second image cluster, a “cluster-specific” weight is assigned for each member of the set of evaluation prompts; for example, where the set of prompts is a₁, a₂, image processing apparatus 110 computes for the first image cluster a first set of weights {w_{1,a}_{₁}, w_{1,a}_{₂}}, and for the second image cluster a second set of weights {w_{2,a}_{₁}, w_{2,a}_{₂}}. A weight w_{z,a}_{ᵢ}∈[0,1]∈ [symbol] (with z, i∈{1,2} in the example shown here) indicates a probability of having prompt aᵢ based on the z-th image cluster (e.g. clustered by category/genre/type). In some embodiments, this process is referred to as grouping the set of evaluation prompts, the first set of weights is referred to as a first group of evaluation prompts, and the second set of weights is referred to as a second group evaluation prompts.

In some embodiments, image processing apparatus 110 groups the set of evaluation prompts based on a set of image clusters comprising the first and the second image clusters. In some cases, the set of image clusters and/or the set of evaluation prompts are/is stored in database 120; alternatively or additionally, the set of image clusters and/or the set of evaluation prompts are/is stored in image processing apparatus 110. Image processing apparatus 110 generates, based on the first group and the second group, the evaluation for the input image, and transmits the evaluation to user 100, e.g. via cloud 115 and user device 105. In some cases, the edited image is transmitted, via cloud 115, to database 120 for storage or further editing.

In the example as shown in FIG. 1, the first image cluster is displayed together with a first evaluation prompt (“best-performing” evaluation prompt for the first image cluster), and the second image cluster is displayed together with a second evaluation prompt (“best-performing” evaluation prompt for the second image cluster). That is, the first image cluster is displayed closer to image processing apparatus 110, the first evaluation prompt is “ . . . a graphic designer with experience in visual clarity and technical image quality . . . ,” and the image processing apparatus 110 determines weights w_{1,a}_{₁}≥w_{1,a}_{₂} (typically, w_{1,a}_{₁}>w_{1,a}_{₂}); on the other hand, the second image cluster is displayed further away from image processing apparatus 110, the second evaluation prompt recites “ . . . a landscape artist skilled in assessing lighting, color, and composition . . . ,” and image processing apparatus 110 determines w_{2,a}_{₂}≥w_{2,a}_{₁} (typically, w_{2,a}_{₂}>w_{2,a}_{₁}). At inference the determination is based on learned weights, so w_{1,a}_{₁} can be substituted with

$${w}_{1 , {a}_{1}}^{*}$$

and so on. In the example shown, the input image depicts a street view with a style closer to a graphic design than to a landscape art, and the evaluation is positive (e.g. labelled as “preferred”, or obtaining a score closer to a right end of an evaluation score interval).

User device 105 may be a personal computer, laptop computer, mainframe computer, palmtop computer, personal assistant, mobile device, or any other suitable generation apparatus. In some examples, user device 105 includes software that incorporates an image processing application (e.g., an image generator, an image editing tool). In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

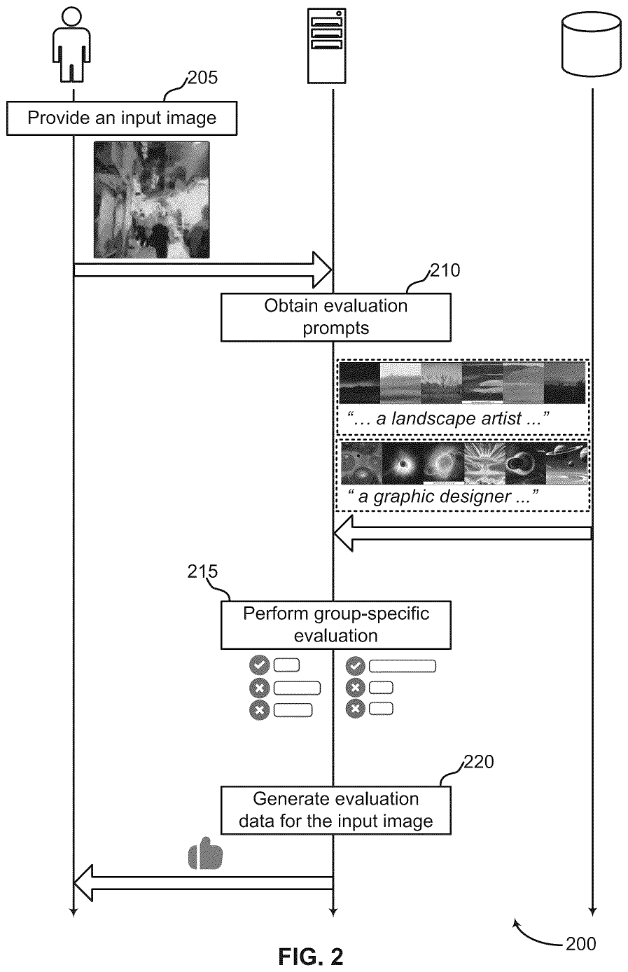

Image processing apparatus 110 includes a computer-implemented network comprising a transformation component, a language generation model, and an image generation model. Image processing apparatus 110 may also include a processor unit, a memory unit, an I/O module, and a user interface. A training component may be implemented on an apparatus other than image processing apparatus 110. The training component is used to train image processing model 625 described with reference to FIG. 6. The training component is an example of, or includes aspects of, training component 650 as described with reference to FIG. 6. Additionally, image processing apparatus 110 can communicate with database 120 via cloud 115. In some cases, the architecture of image processing apparatus 110 is also referred to as a network, a machine learning model, or a network model. Further detail regarding the architecture of image processing apparatus 110 is provided with reference to FIGS. 6-12. Further detail regarding the operation of image processing apparatus 110 is provided with reference to FIGS. 2, 5, 7, and 13-16.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable generation apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., dataset for training an image processing model, or evaluation prompts) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of a method 200 for conditional image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 205, the user provides an input image to an image processing apparatus. In some cases, the operations of this step refer to, or may be performed by, a user 100 as described with reference to FIG. 1, and the image processing apparatus is an example of, or includes aspects of, image processing apparatus 110 as described with reference to FIG. 1. The input image can be a raster image or a vector image. In the example shown, the input image depicts a (crowded) street view with a style closer to a graphic design than to e.g. a landscape image, as described with reference to FIG. 1.

At operation 210, the image processing apparatus obtains evaluation prompts. In some cases, the operations of this step refer to, or may be performed by, a database as described with reference to FIG. 1; for example, the evaluation prompts can be stored on database 120. I some examples, the image processing apparatus (e.g. image processing apparatus 110) further obtains a set of image clusters, where for each image cluster, the image processing apparatus computes a set of weights indexed by the evaluation prompts. In the example shown, a first image cluster is a cluster of landscape images, and a second image cluster is a cluster of graphic design images; thus, for the first image cluster, a weight of a first evaluation prompt “ . . . a landscape artist . . . ” is higher than a weight of a second evaluation prompt “ . . . a graphic designer . . . ,” and vice versa for the second image cluster. In the example shown, the first image cluster is displayed with its “best-performing” evaluation prompt, namely the first evaluation prompt, and the second image cluster with the second evaluation prompt. The database (e.g. database 120) transmits the set of image clusters and the set of evaluation prompts to the image processing apparatus.

At operation 215, the system performs group-specific evaluation. In some cases, the operations of this step refer to, or may be performed by, an image processing apparatus as described with reference to FIGS. 1 and 5-7. The group-specific evaluation is performed based on cluster-specific weights of the evaluation prompts as described at operation 210 or grouping the set of evaluation prompts as described with reference to FIG. 1. In some embodiments, each group-specific evaluation is further based on prompt-specific evaluation data for the input image, as described with reference to FIG. 6. In the example shown, for the first image cluster g₁ (landscape), the second image cluster g₂ (graphic design), the first evaluation prompt a₁ (“ . . . a landscape artist . . . ”), the second evaluation prompt a₂ (“ . . . a graphic designer . . . ”), a third evaluation prompt a₃ (unshown in FIG. 2), input image x and evaluation y (“preferred”), In the example shown, (intermediate) evaluations specific to the first group satisfies w₁ₐ_{₁}·p(y|x, a₁)<w₁ₐ_{₃}·p(y|x, a₃)<w₁ₐ_{₂}·p(y|x, a₂), and (intermediate) evaluations specific to the second group satisfies w₂ₐ_{₂}·p(y|x, a₂)≈w₂ₐ_{₃}·p(y|x, a₃)<w₂ₐ_{₁}·p(y|x, a₁), as illustrated by respective lengths of bars under the text block of operation 215. “Tick” symbols in the figure indicate that a₁ is a best-performing prompt (referring e.g. to operation 210) for g₁ and 2 is a best-performing evaluation prompt for g₂.

The {w₁ₐ_{ᵢ}}_{i∈{1,2,3}} and {w₂ₐ_{ᵢ}}_{i∈{1,2,3}} are referred to as groupings of evaluation prompts where w_{z,a}_{ᵢ} is a weight (e.g. with values in a range of [0,1]⊂ [symbol] ) corresponding to image cluster g_{z} and prompt aᵢ, indicating e.g. probability of having prompt aᵢ based on image cluster g_{z}; and p(y|x, aᵢ)s (i∈{1,2,3}) are prompt-specific evaluation data for the input image (e.g. probability of observing evaluation y based on evaluation prompt aᵢ and input image x). The groupings {w₁ₐ_{ᵢ}}_{i∈{1,2,3}} and {w₂ₐ_{ᵢ}}_{i∈{1,2,3}} can be performed by an image processing model included in the image processing apparatus (referring e.g. to FIGS. 6-7 and 16); at inference, weights in the groupings are learned and may be denoted with a “*” in superscript (e.g. w_{1,a}_{₁} can be substituted with

$${w}_{1 , {a}_{1}}^{*}$$

and so on), at training, the weights are being trained.

At operation 220, the system generates evaluation data for the input image. In some cases, the operations of this step refer to, or may be performed by, an image processing apparatus as described with reference to FIGS. 1 and 5-7. In some embodiments, the evaluation data (e.g. p(y|x) for input image x) is generated by first performing group-specific weighted sums of the group-specific evaluation data, and computing a cross-group weighted sum of the group-specific weighted sums, where the cross-group weighted sum is based on group-assignment values. In the example shown, since the input image exhibits a style closer to a graphic design than to e.g. a landscape image, image processing apparatus determines that group-assignment values p(1|x)<p(2|x), i.e. a probability of observing second image cluster g₂ based on input image x or assigning input image x to group g₂ is greater than a probability of observing first image cluster g₁ based on input image x.

Having computed the group-specific weighted sums and cross-group weighted sum, image processing apparatus generates the evaluation data (“preferred” as represented by an upward pointing thumb) for the input image, e.g. by computing an expectation of variable y based on the set of probabilities {p(y|x)}_{y}, or e.g. taking as output an evaluation with a maximum estimated probability, or e.g. returning “preferred” upon finding p(y|x) is greater than a threshold for y=“preferred.” More details on computing the group-specific weighted sums and cross-group weighted sum are included with reference to FIGS. 7 and 16.

FIG. 3 shows an example of an evaluation prompt according to aspects of the present disclosure. The example shown includes settings text 300, image prompt 305, and query text 310. The example shown is an example of, or includes aspects of, one (member) of a set of evaluation prompts as described with reference to FIGS. 1-2.

In the example shown, settings text 300 describes a role of a user (e.g. “you are a technical expert at evaluating ‘text-to-image’ alignment and aesthetics,” a task for the user (e.g. “ . . . to assess the quality of two images generated from the same prompt,” criteria for evaluation (e.g. “Image Quality,” “Image Artifacts,” “Be objective . . . ,” and further description in the text), and includes a caption (“Caption: [INPUT PROMPT]”). In some examples such as the one shown, in image prompt 305, the evaluation prompt refers to or copies an input image as described with reference to FIG. 1, where an input image includes a first image and a second image, and evaluation is a preference between the first and the second image e.g. represented as a Boolean value or class label. Query text 310 provides a call for evaluation indicating the nature and form of evaluation (e.g. “Which of the two images do you prefer?”).

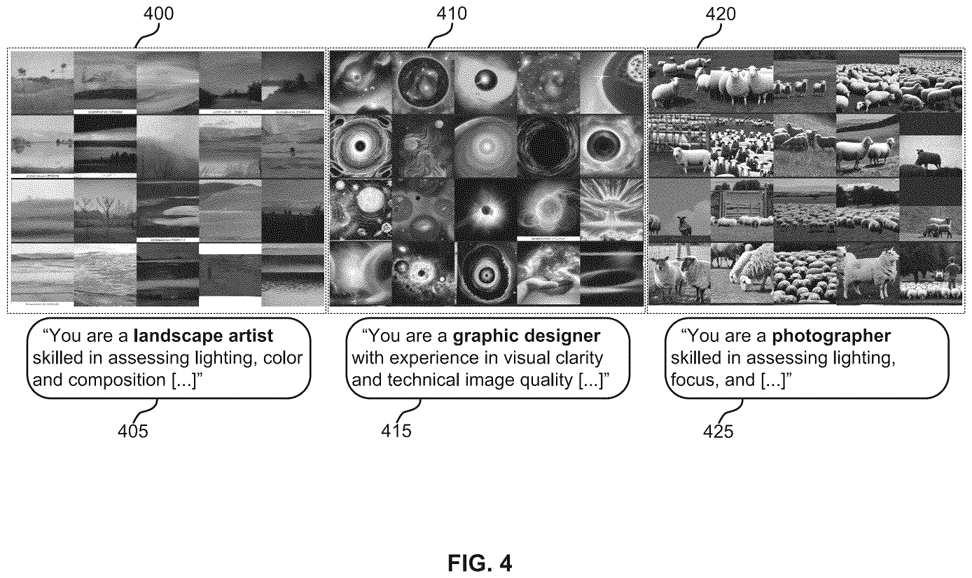

FIG. 4 shows an example of groups of evaluation prompts according to aspects of the present disclosure. The example shown includes first image cluster 400, second image cluster 410, and third image cluster 420. First image cluster 400 is displayed with corresponding a “best-performing” prompt, the first evaluation prompt 405; second image cluster 410 is displayed with corresponding a “best-performing” prompt, the second evaluation prompt 415; and similarly, third image cluster 420 is displayed with a corresponding “best-performing” prompt the third evaluation prompt 425.

As described with reference to FIGS. 1 and 3, for each of the three image clusters g₁ (first image cluster 400), g₂ (second image cluster 410) and g₃ (third image cluster 420), image processing apparatus (e.g. image processing apparatus 110) determines a group-specific weight for each of the three evaluation prompts a₁ (first evaluation prompt 405), a₂ (second evaluation prompt 415), and 3 (third evaluation prompt 425). A first group of evaluation prompts refers to {w₁ₐ_{ᵢ}}_{i∈{1,2,3}}, a second group of evaluation prompts refers to {w₂ₐ_{ᵢ}}_{i∈{1,2,3}} and a third group of evaluation prompts refers to {w₃ₐ_{ᵢ}}_{i∈{1,2,3}}, where w_{z,a}_{ᵢ} is a weight corresponding to group g_{z} and prompt aᵢ indicating a probability for aᵢ based on group g_{z} (e.g. grouped by category/genre/type of images). “Best performing” or best-performing prompt for a group refers to a prompt a indexing a maximum weight within the group.

In the example shown, first image cluster 400 (g₁) is a cluster of landscape images (depicting e.g. trees, water body and hills), second image cluster 410 (g₂) is a cluster of graphic design images (depicting e.g. shapes including concentric or sporadic circles with intensive lighting effects), and third image cluster 420 (g₃) is a cluster of natural photograph images (mostly depicting sheep or a person). First evaluation prompt 405, second evaluation prompt 415 and third evaluation prompt 425 set up roles of user (e.g. user 100 as described with reference to FIG. 1) as a landscape artist, a graphic designer and a photographer, respectively. As such, in the example shown, for each i∈{1,2, 3}, w_{i,a}_{ᵢ}>max_{j≠i}(w_{i,a}_{ⱼ}), and a respective “best-performing” prompt for each image cluster is determined and displayed accordingly.

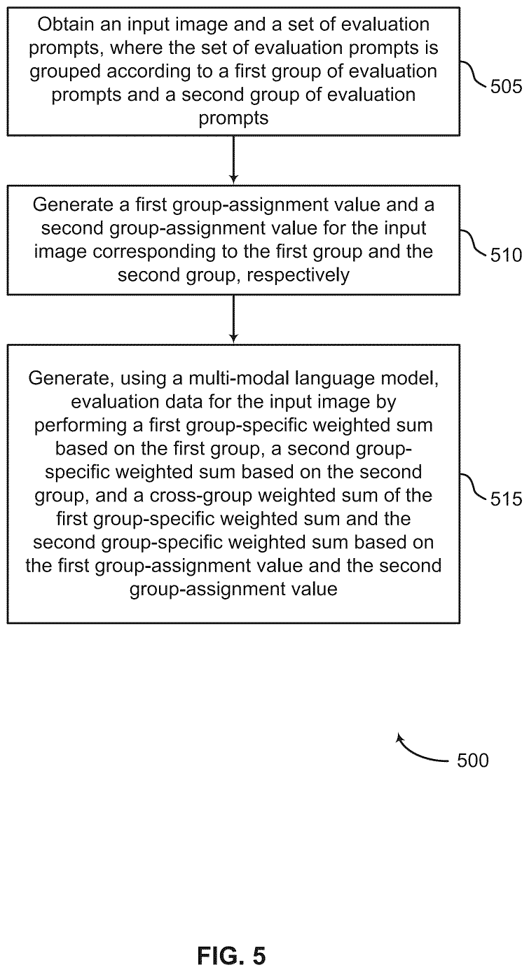

FIG. 5 shows an example of a method 500 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 505, the system obtains an input image and a set of evaluation prompts, where the set of evaluation prompts is grouped according to a first group of evaluation prompts and a second group of evaluation prompts. In some cases, the operations of this step refer to, or may be performed by, an image processing model as described with reference to FIGS. 6-7, and 16. Groupings of evaluation prompts relate to group-specific weights, where

$${w}_{z , {a}_{i}}^{*}$$

at inference (or w_{z,a}_{ᵢ} at training) indicates a probability of having evaluation prompt aᵢ based on image cluster g_{z}, with aᵢ∈a (set of evaluation prompts), 1≤z≤K, and K is a total number of image clusters reflecting e.g. differences in genre/type/category. “A first group of evaluation prompts” also refers to a first set of group-specific weights (e.g.

$${\{ {{w}_{1 , a}^{*}}_{i} \}}_{{a}_{i} ∈ a}$$

at inference or {w_{1,a}_{ᵢ}}ₐ_{ᵢ}_{∈a} at training, referring respectively to FIGS. 7 and 16), “a second group of evaluation prompts” also refers to a second set of group-specific weights denoted and described analogously.

At operation 510, the system generates a first group-assignment value and a second group-assignment value for the input image corresponding to the first group and the second group, respectively. In some cases, the operations of this step may be performed by a group-assignment component as described with reference to FIG. 6, with more details described with reference to FIGS. 7 and 16. Particularly, a first group-assignment value and a second group-assignment value respectively indicates a probability for input image to be assigned to a first image cluster g₁ or a second image cluster g₂.

At operation 515, the system generates, using a multi-modal language model, evaluation data for the input image by performing a first group-specific weighted sum based on the first group, a second group-specific weighted sum based on the second group, and a cross-group weighted sum of the first group-specific weighted sum and the second group-specific weighted sum based on the first group-assignment value and the second group-assignment value. In some cases, the operations of this step refer to, or may be performed by, an image processing model as described with reference to FIGS. 6-7, and 16. “First group-specific weighted sum,” “Second group-specific weighted sum,” and cross-group weighted sum are described in more detail with reference to FIG. 7.

In FIGS. 1-5, a method, apparatus, non-transitory computer readable medium, and system for media processing are described. One or more aspects of the method, apparatus, non-transitory computer readable medium, and system include obtaining an input image and a set of evaluation prompts, where the set of evaluation prompts is grouped according to a first group of evaluation prompts and a second group of evaluation prompts; generating a first group-assignment value and a second group-assignment value for the input image corresponding to the first group and the second group, respectively; and generating, using a multi-modal language model, evaluation data for the input image by performing a first group-specific weighted sum based on the first group, a second group-specific weighted sum based on the second group, and a cross-group weighted sum of the first group-specific weighted sum and the second group-specific weighted sum based on the first group-assignment value and the second group-assignment value.

In some examples of the method, apparatus, non-transitory computer readable medium, and system, obtaining an input image includes generating the input image using an image generation model.

Some examples of the method, apparatus, non-transitory computer readable medium, and system further include clustering a set of supporting images to obtain a plurality of image clusters. Some examples further include grouping the set of evaluation prompts based on the plurality of image clusters to obtain the first group and the second group.

Some examples of the method, apparatus, non-transitory computer readable medium, and system further include computing a first set of group-specific weights over the set of evaluation prompts for the first group and a second set of group-specific weights over the set of evaluation prompts for the second group, wherein the first group-specific weighted sum is based on the first set of group-specific weights and the second group-specific weighted sum is based on the second set of group-specific weights.

In some aspects, the first set of group-specific weights and the second set of group-specific weights are trained by optimizing a machine-learning objective using ground-truth evaluation data.

In some examples of the method, apparatus, non-transitory computer readable medium, and system, generating the first group-assignment value and the second group-assignment value includes computing a similarity function based on the input image to obtain the first group-assignment value and the second group-assignment value.

In some examples of the method, apparatus, non-transitory computer readable medium, and system, generating the evaluation data includes generating, using the multi-modal language model, prompt-specific evaluation data for the input image corresponding to each of the set of evaluation prompts, wherein the first group-specific weighted sum and the second group-specific weighted sum are based on the prompt-specific evaluation data.

### Network Architecture

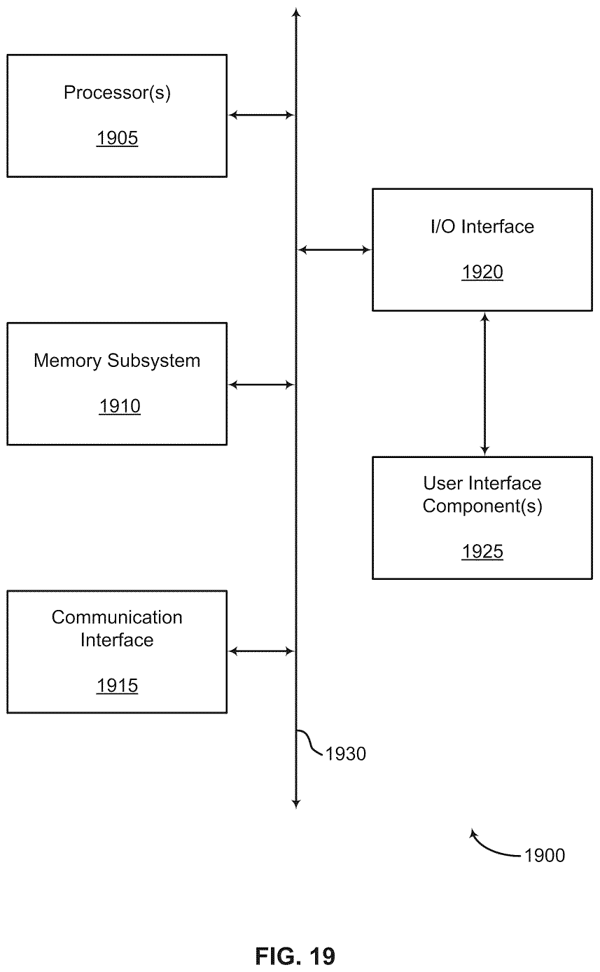

FIG. 6 shows an example of an image processing apparatus 600 according to aspects of the present disclosure. The example shown includes image processing apparatus 600, processor unit 605, I/O module 610, user interface 615, memory unit 620, image processing model 625, and training component 650. Image processing apparatus 600 is an example of, or includes aspects of, the corresponding element described with reference to FIG. 1. I/O module 610 and user interface 615 are examples of or include aspects of the corresponding elements as described with reference to FIG. 19, such as I/O interface 1920 and user interface component(s) 1925 respectively. In some cases, the training component 650 is implemented in an apparatus external to image processing apparatus 600. In some embodiments, training component 650 is configured to perform operations as described with reference to FIG. 16-18.

Processor unit 605 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. According to some aspects, processor unit 605 comprise a processing device coupled to the memory component, the processing device configured to perform operations as described with reference to FIGS. 2, 5, 7, and 13-16.

In some cases, processor unit 605 is configured to operate a memory array using a memory controller. In other cases, a memory controller is integrated into processor unit 605. In some cases, processor unit 605 is configured to execute computer-readable instructions stored in memory unit 620 to perform various functions. In some aspects, processor unit 605 includes special purpose components for modem processing, baseband processing, digital signal processing, or transmission processing.

I/O module 610 receives inputs from and transmits outputs of the image processing apparatus 600 to other devices or users. For example, I/O module 610 receives inputs for the image processing model 625 and transmits outputs of the image processing model 625. According to some aspects, I/O module 610 is an example of the I/O interface 1920 described with reference to FIG. 19.

Memory unit 620 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 605 to perform various functions described here. According to some aspects, memory unit 620 comprise a memory component.

In some cases, memory unit 620 includes a basic input/output system (BIOS) that controls basic hardware or software operations, such as an interaction with peripheral components or devices. In some cases, memory unit 620 includes a memory controller that operates memory cells of memory unit 620. For example, the memory controller may include a row decoder, column decoder, or both. In some cases, memory cells within memory unit 620 store information in the form of a logical state. According to some aspects, memory unit 620 is an example of memory subsystem 1910 described with reference to FIG. 19.

According to some aspects, image processing apparatus 600 uses one or more processors of processor unit 605 to execute instructions stored in memory unit 620 to perform functions described here. For example, image processing apparatus 600 may an input image and a set of evaluation prompts, where the set of evaluation prompts is grouped according to a first group of evaluation prompts and a second group of evaluation prompts; image processing apparatus 600 can generate (e.g. using group-assignment component 645 of the image processing model 625) a first group-assignment value and a second group-assignment value for the input image corresponding to the first group and the second group, respectively; and generate, using the image processing model 625 including multi-modal language model 635, evaluation data for the input image by performing a first group-specific weighted sum based on the first group, a second group-specific weighted sum based on the second group, and a cross-group weighted sum of the first group-specific weighted sum and the second group-specific weighted sum based on the first group-assignment value and the second group-assignment value.

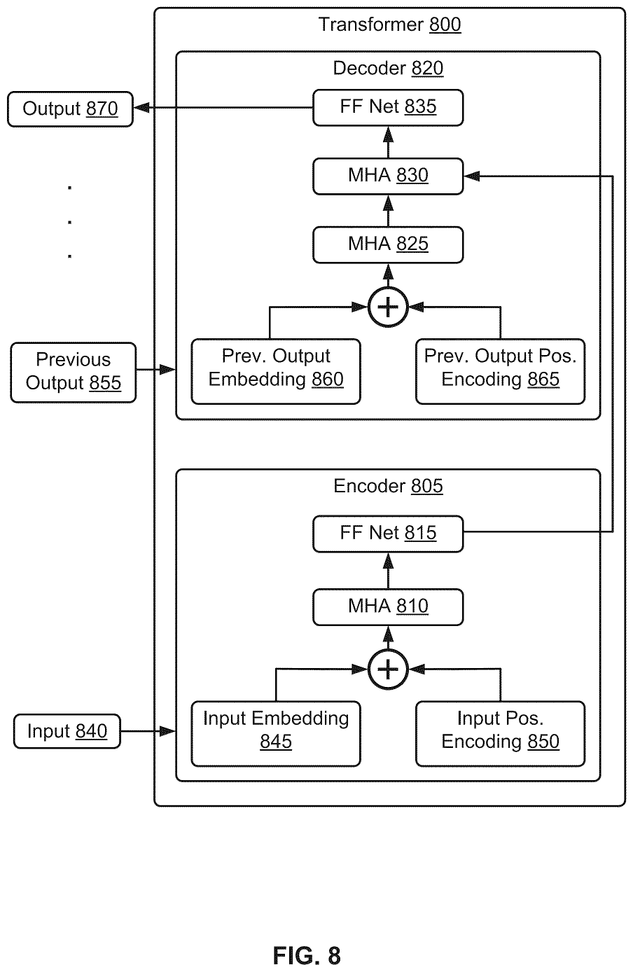

In some embodiments, image processing model 625 is an artificial neural network (ANN) including a transformer model as described with reference to FIG. 8. For example, after being trained by training component 650, image processing model 625 performs operations at inference time as described with reference to FIGS. 2, 5, 7, and 13-16.

An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image processing model 625 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

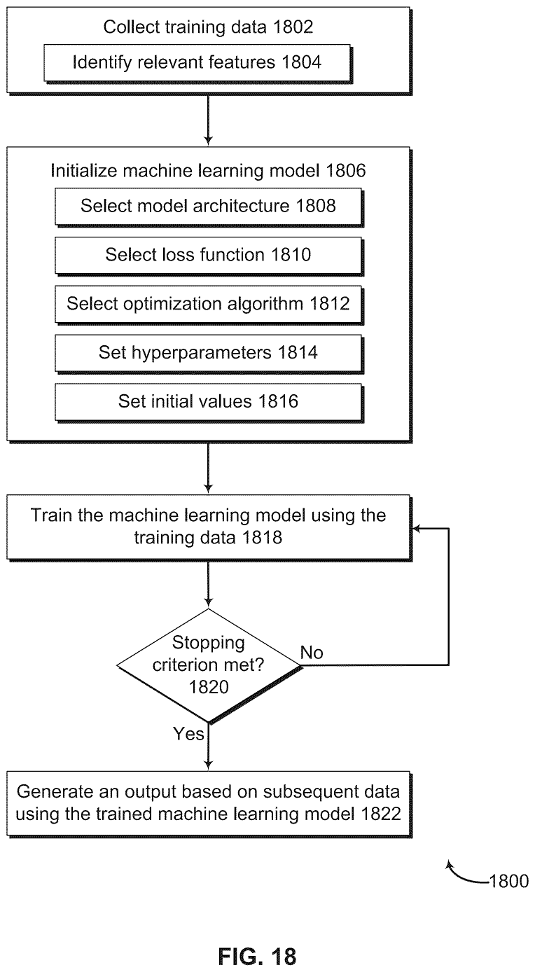

Training component 650 is used to train the image processing model 625. For example, parameters of image processing model 625 may be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 18). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image processing model 625 can be used to make predictions on new, unseen data (i.e., during inference).

Image processing model 625 is an example of, or includes aspects of, the corresponding element described with reference to FIGS. 7 and 16. According to some aspects, image processing model 625 obtains an input image and a set of evaluation prompts, where the set of evaluation prompts is grouped according to a first group of evaluation prompts and a second group of evaluation prompts. In some examples, image processing model 625 generates, using a multi-modal language model 635, evaluation data for the input image by performing a first group-specific weighted sum based on the first group, a second group-specific weighted sum based on the second group, and a cross-group weighted sum of the first group-specific weighted sum and the second group-specific weighted sum based on the first group-assignment value and the second group-assignment value. In some examples, image processing model 625 computes a first set of group-specific weights over the set of evaluation prompts for the first group and a second set of group-specific weights over the set of evaluation prompts for the second group, where the first group-specific weighted sum is based on the first set of group-specific weights and the second group-specific weighted sum is based on the second set of group-specific weights. In some aspects, the first set of group-specific weights and the second set of group-specific weights are trained by optimizing a machine-learning objective using ground-truth evaluation data.

According to some aspects, image processing model 625 obtains an input image and a set of evaluation prompts grouped in a set of groups. In some examples, image processing model 625 computes, using a multi-modal language model 635, a group-specific weighted sum of outputs of the multi-modal language model 635 based on the set of evaluation prompts to obtain group-specific sum result. In some examples, image processing model 625 generates evaluation data for the input image by performing a cross-group weighted sum based on the group-specific sum result. In some examples, image processing model 625 weights the prompt-specific evaluation data for each of the set of evaluation prompts based on a set of group-specific weights corresponding to each of the set of groups. In some aspects, the set of group-specific weights corresponding to each of the set of groups is trained by optimizing a machine-learning objective using ground-truth evaluation data.

According to some aspects, image processing model 625 obtains an input image and a set of evaluation prompts, where the set of evaluation prompts is grouped according to a first group of evaluation prompts and a second group of evaluation prompts. In some examples, image processing model 625 comprise generates a first group-assignment value and a second group-assignment value for the input image corresponding to the first group and the second group, respectively. In some examples, image processing model 625 generates, using a multi-modal language model 635, evaluation data for the input image by performing a first group-specific weighted sum based on the first group, a second group-specific weighted sum based on the second group, and a cross-group weighted sum of the first group-specific weighted sum and the second group-specific weighted sum based on the first group-assignment value and the second group-assignment value.

In one aspect, image processing model 625 includes image generation model 630, multi-modal language model 635, clustering component 640, and group-assignment component 645.

According to some aspects, image generation model 630 generates, or is configured to generate, the input image. Image generation model 630 is an example of, or includes aspects of, the corresponding element described with reference to FIGS. 7 and 16.

According to some aspects, multi-modal language model 635 generates prompt-specific evaluation data for the input image corresponding to each of the set of evaluation prompts, where the first group-specific weighted sum and the second group-specific weighted sum are based on the prompt-specific evaluation data.

In some aspects, the multi-modal language model 635 includes an autoregressive transformer model. In some aspects, the multi-modal language model 635 is configured to take text input and image input. Multi-modal language model 635 is an example of, or includes aspects of, the corresponding element described with reference to FIGS. 7 and 16.

According to some aspects, clustering component 640 clusters, or is configured to cluster, a set of supporting images to obtain a plurality of image clusters. According to some aspects, clustering component 640 groups or is configured to group the set of evaluation prompts based on the plurality of image clusters to obtain the plurality of groups to obtain a first group and a second group. According to some aspects, clustering component 640 clusters a set of supporting images to obtain a set of image clusters, and groups the set of evaluation prompts based on the plurality of image clusters to obtain the set of groups.

According to some aspects, group-assignment component 645 generates a first group-assignment value and a second group-assignment value for the input image corresponding to the first group and the second group, respectively. In some examples, group-assignment component 645 computes a similarity function based on the input image to obtain the first group-assignment value and the second group-assignment value.

According to some aspects, group-assignment component 645 determines a group-assignment value for each of the set of groups, where the cross-group weighted sum is based on the group-assignment value. In some examples, group-assignment component 645 computes a similarity function based on the input image, where the group-assignment value is based on the similarity function. According to some aspects, group-assignment component 645 is configured to compute the first group-assignment value and the second group-assignment value.

FIG. 7 shows an example of an image processing model 700 according to aspects of the present disclosure. The example shown includes image processing model 700, set of evaluation prompts 705, image generation model 710, input image 715, multi-modal language model 720, prompt-specific evaluation data 725, similarity function 730, group-assignment values 735, group-specific weights 740, paired sets of group-specific weights 745, evaluation data generation 760, and evaluation data 765.

Before inference, image generation model 710 has generated a test set of images containing input image 715 (denoted as x) and a set of supporting images Dₛᵤₚ, clustering component 640 (as described with reference to FIG. 6) has partitioned Dₛᵤₚ into K groups g₁, . . . , g_{K} (K≥2), and image processing model 700 has learned the group-specific weights 740

$${w}_{za}^{*}$$

for each z∈{1, . . . ,K} and each a∈a, where a denotes set of evaluation prompts 705).

In FIG. 7, image processing model 700 is at inference stage, where image generation model 710 and multi-modal language model 720 are frozen. Multi-modal language model 720 obtains set of evaluation prompts 705 (a), for example from database 120 (referring to FIGS. 1-2), and obtains input image 715 (x), for example from user 100 (referring to FIGS. 1-2). Multi-modal language model 720 generates prompt-specific evaluation data 725 (p(y|x, aᵢ) for each aᵢ ∈a).

On the other hand, group-assignment component 645 (referring to FIG. 6) computes a similarity function 730 (sim(φ_{I}(x), g_{z}) for each z∈{1, . . . , K}) based on the input image 715, and generates group-assignment values 735 (p(z|x) for each z∈{1, . . . , K}) based on similarity function 730. Prompt-specific evaluation data 725, group-specific weights 740, and group-assignment values 735 are collected into paired sets of group-specific weights 745 for processing via evaluation data generation 760.

Paired sets of group-specific weights 745 includes first paired set of group-specific weights 750, second paired set of group-specific weights 755, and paired sets of group-specific weights respectively corresponding to other groups g_{z} (z∈{3, . . . , K}) in cases where K>2. In some embodiments, first paired set of group-specific weights 750 includes data

$$( {\{ {w}_{1 , {a}_{i}}^{*} , p ( y \vert x , {a}_{i} ) \}}_{{a}_{i} ∈ a} , p ( 1 \vert x ) ) ,$$

second paired set of group-specific weights 755 includes data

$$( {\{ {w}_{2 , {a}_{i}}^{*} , p ( y \vert x , {a}_{i} ) \}}_{{a}_{i} ∈ a} , p ( 2 \vert x ) ) , etc .$$

At evaluation data generation 760, image generation model 710, using paired sets of group-specific weights 745, performs group-specific weighted sums (e.g. first group-specific weighted sum

$${\sum }_{a ∈ a} ( {w}_{1 a}^{*} \cdot p ( y \vert x , a ) ) ,$$

second group-specific weighted

$$sum {\sum }_{a ∈ a} ( {w}_{2 a}^{*} \cdot p ( y \vert x , a ) ) , etc . ) ,$$

performs cross-group weighted sums (further weighing each group-specific weighted sum with the corresponding p(z|x) and summing up the results across groups), and generates evaluation data 765 for input image 715. In some embodiments, evaluation data 765 is a predicted probability p(y|x) of observing an evaluation result for input image 715 generated via

$$p ( y \vert x ) \approx {\sum }_{z} p ( z \vert x ) {\sum }_{a} {w}_{za}^{*} p ( y \vert x , a ) , \qquad ( 1 )$$

where z ranges over {1, . . . , K} and a ranges over set of evaluation prompts 705 (a). In some embodiments, a right-hand side of Eq. (1) is referred to as cross-group weighted sum. In some embodiments, evaluation data 765 includes an expectation of evaluation result computed based on Eq. (1). For example, in cases where the set [symbol] of evaluation results is a finite set of numerical values, an expected evaluation result can be computed via [symbol] y·p(y|x).

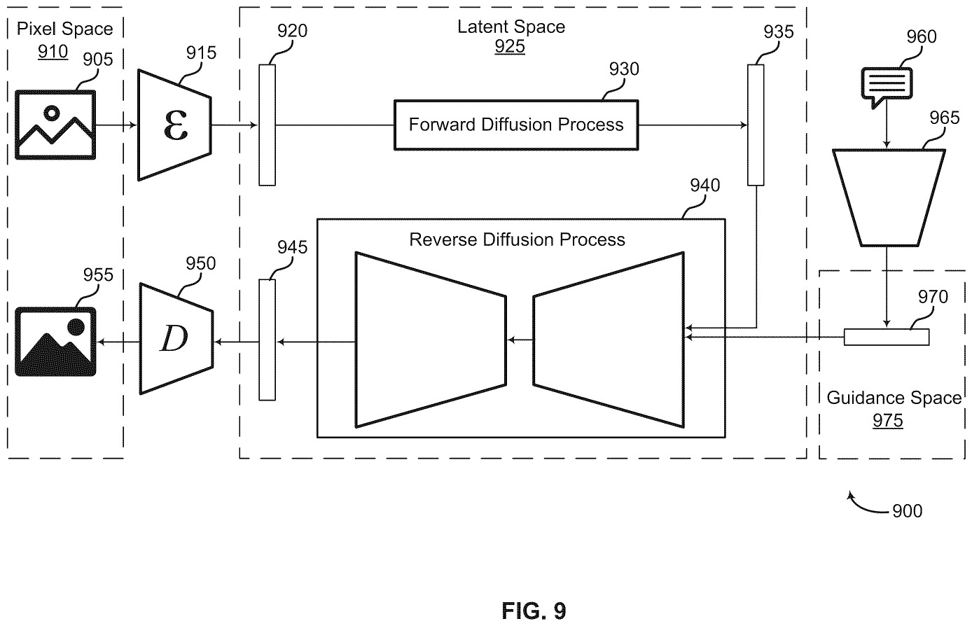

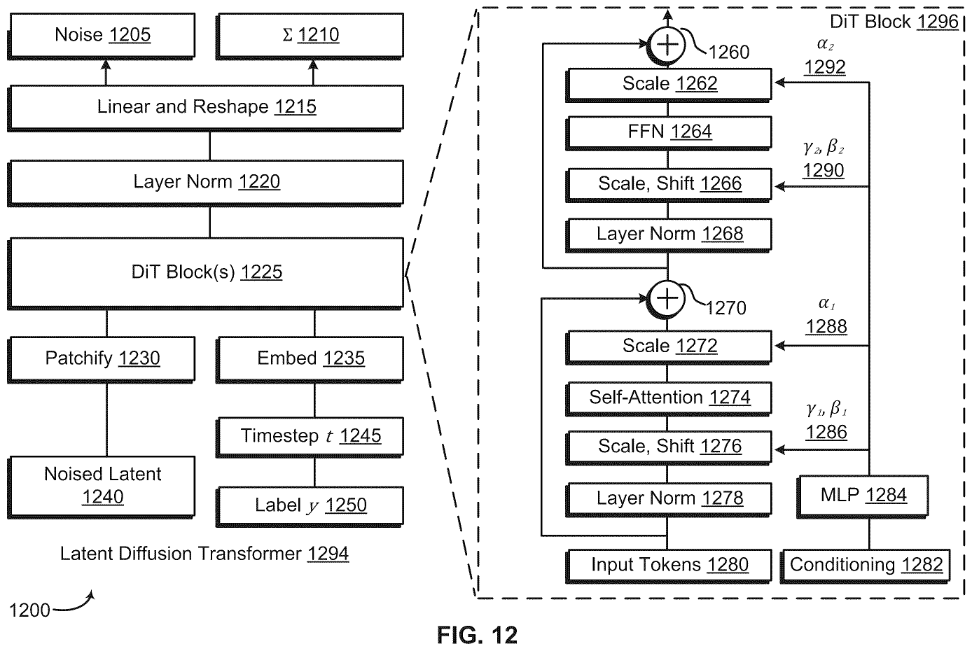

Image processing model 700 is an example of, or includes aspects of, the corresponding element described with reference to FIGS. 6 and 16. Image generation model 710 is an example of, or includes aspects of, the corresponding element described with reference to FIGS. 6 and 16. In some cases, image generation model 710 comprises a diffusion transformer as described with reference to FIG. 12, or generally a guided diffusion model as described with reference to FIG. 9, or generally a transformer-based model as described with reference to FIG. 8. Before inference (in some embodiments also before training), image generation model 710 generates a test set of images including input image 715 (x); before inference in some embodiments also before training), image generation model 710 generates the set Dₛᵤₚ of supporting images that are unlabeled, which are drawn independently identically distributed by image generation model 710.

Set of evaluation prompts 705 (a={a₁, . . . , a_{N}}; generally N≥2) is an example of, or includes aspects of, the corresponding element described with reference to FIG. 16. Each aᵢ ∈a describes a classification or preference task. Each evaluation prompt can be a text prompt or image prompt; in some embodiments, an evaluation prompt refers to or includes a copy of input image 715 (x). Examples of sets of evaluation prompts are described with reference to FIGS. 1-2 and 4. An example of an (individual) evaluation prompt is described in FIG. 3.

Multi-modal language model 720 is an example of, or includes aspects of, the corresponding element described with reference to FIGS. 6 and 16. Prompt-specific evaluation data 725 ({p(y|x, aᵢ)}ₐ_{ᵢ}_{∈a}) is an example of, or includes aspects of, the corresponding element described with reference to FIG. 16. As described above, multi-modal language model 720 obtains the set of evaluation prompts 705 and input image 715, and generates prompt-specific evaluation data 725 ({p(y|x, aᵢ)}ₐ_{ᵢ}_{∈a}) accordingly.

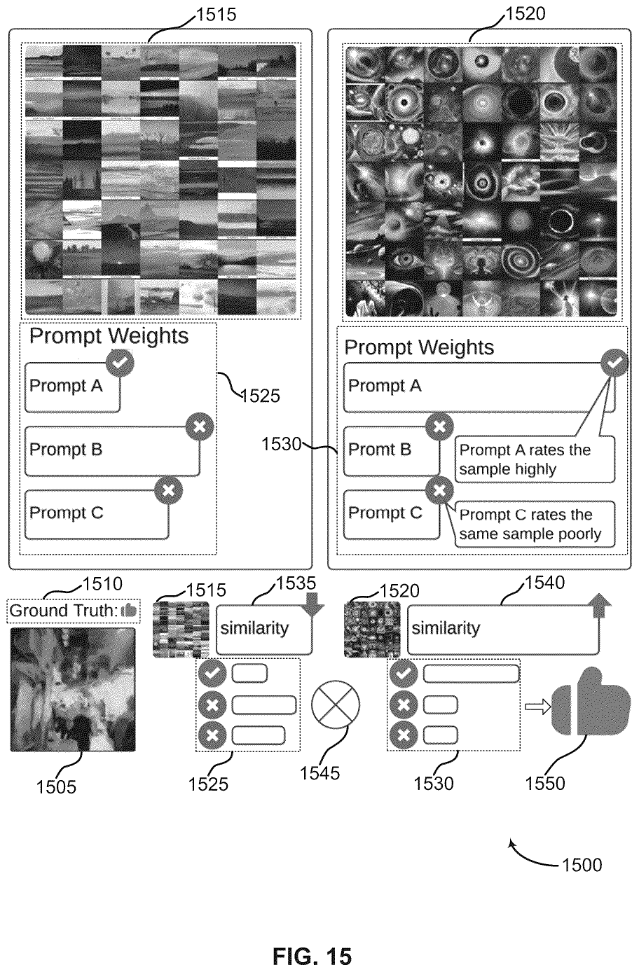

Input image 715 (x) includes aspects of the corresponding element described with reference to FIGS. 15-16. Input image 715 (x) is contained in the test set of images and input image 1615 (xⱼ) (referring to FIG. 16 where image processing model 1600 is at training) is contained in a validation set of images; the test set and the validation set are typically disjoint. In some embodiments, input image 715 includes a pair of images, and evaluation data 765 includes a categorical or numerical value indicating a preference between the pair of images.

A set of image clusters g₁, . . . , g_{K} (K≥2) has generated before inference (in some embodiments also before training) via clustering component 640 (as described with reference to FIG. 6) by partitioning the set Dₛᵤₚ of supporting images. Particularly, when performing the clustering operation, clustering component 640 uses e.g. a machine learning model or algorithms such as k-means. “k” in “k-means” is distinguished from the number K of groups.

Similarity function 730 is an example of, or includes aspects of, the corresponding element described with reference to FIG. 16. Similarity function 730 is evaluated, at inference, by group-assignment component 645 on input image 715 (x) based on comparison between input image 715 (x) and the set of image clusters g₁, . . . , g_{K} (K≥2). Particularly, group-assignment component 645 computes an image embedding function φ₁: X→ [symbol] ^{d} (for some integer d≥1, for instance, via a pretrained image encoder) of input image 715 (x), then evaluates sim (φ_{I}(x), g_{z}) between the image embedding of x (i.e. φ_{I}(x)) and an embedding of a group g_{z} for each z∈{1, . . . , K}). In some embodiments, the image embedding function φ_{I} includes a Contrastive Language-Image Pre-training (CLIP) embedding, and similarity function 730 evaluates a similarity between the CLIP embedding of x and the CLIP embedding of a group g_{z}.

Group-assignment values 735 ({p(z|x)}_{z∈{1, . . . ,K}}) is an example of, or includes aspects of, the corresponding element described with reference to FIG. 16. Group-assignment component 645 generates group-assignment values 735 based on similarity function 730. Particularly, each p(z|x)∝exp(sim(φ_{I}(x), g_{z})/τ), where in some embodiments ∝ denotes proportional to or “can be approximated by” and where τ is a temperature scale hyperparameter. For τ→0, p(z|x) tends to a one-hot hard assignment; on the other and p(z|x) tends to a uniform distribution for τ→inf (i.e. τ→∞). This distribution (p(z|x) for each z∈{1, . . . , K}) can be viewed as a soft assignment of x to each of the K groups. Due to multi-modality and image group awareness, image processing model 700 is based on Multimodal Mixture-of-Bayesian Prompt Ensembles (MMB); when τ→∞, p(z|x) tends to a single over-parameterized Bayesian Prompt Ensembles (BPE) for all data.

Evaluation data generation 760, an operation to generate evaluation data 765, is an example of, or includes aspects of, the corresponding element described with reference to FIG. 15. Evaluation data generation 760 includes generating group-specific weighted sums and cross-group weighted sum based on paired sets of group-specific weights 745 as described.

FIG. 8 shows an example of a transformer model according to aspects of the present disclosure. The example shown includes transformer 800, encoder 805, decoder 820, input 840, input embedding 845, input positional encoding 850, previous output 855, previous output embedding 860, previous output positional encoding 865, and output 870.

In some cases, encoder 805 includes multi-head self-attention sublayer 810 and feed-forward network sublayer 815. In some cases, decoder 820 includes first multi-head self-attention sublayer 825, second multi-head self-attention sublayer 830, and feed-forward network sublayer 835.

According to some aspects, a machine learning model (such as the image processing model described with reference to FIGS. 6-7 and 16) comprises transformer 800. In some cases, encoder 805 is configured to map input 840 (for example, a query or a prompt comprising a sequence of words or tokens) to a sequence of continuous representations that are fed into decoder 820. In some cases, decoder 820 generates output 870 (e.g., a prediction of an output sequence of words or tokens) based on the output of encoder 805 and previous output 855 (e.g., a previously predicted output sequence), which allows for the use of autoregression.

For example, in some cases, encoder 805 parses the input 840 into tokens and vectorizes the parsed tokens to obtain input embedding 845, and adds input positional encoding 850 (e.g., positional encoding vectors for input 840 of a same dimension as input embedding 845) to input embedding 845. In some cases, input positional encoding 850 includes information about relative positions of words or tokens in input 840.

In some cases, encoder 805 comprises one or more encoding layers (e.g., six encoding layers) that generate contextualized token representations, where each representation corresponds to a token that combines information from other input tokens via self-attention mechanism. In some cases, each encoding layer of encoder 805 comprises a multi-head self-attention sublayer (e.g., multi-head self-attention sublayer 810). In some cases, the multi-head self-attention sublayer implements a multi-head self-attention mechanism that receives different linearly projected versions of queries, keys, and values to produce outputs in parallel. In some cases, each encoding layer of encoder 805 also includes a fully connected feed-forward network sublayer (e.g., feed-forward network sublayer 815) comprising two linear transformations surrounding a Rectified Linear Unit (ReLU) activation:

FFN(x)=ReLU(W₁x+b₁)W₂+b₂ (2)

In some cases, each layer employs different weight parameters (W₁, W₂) and different bias parameters (b₁, b₂) to apply a same linear transformation each word or token in input 840.

In some cases, each sublayer of encoder 805 is followed by a normalization layer that normalizes a sum computed between a sublayer input x and an output sublayer (x) generated by the sublayer:

layernorm(x+sublayer(x)) (3)

In some cases, encoder 805 is bidirectional because encoder 805 attends to each word or token in input 840 regardless of a position of the word or token in input 840.

In some cases, decoder 820 comprises one or more decoding layers (e.g., six decoding layers). In some cases, each decoding layer comprises three sublayers including a first multi-head self-attention sublayer (e.g., first multi-head self-attention sublayer 825), a second multi-head self-attention sublayer (e.g., second multi-head self-attention sublayer 830), and a feed-forward network sublayer (e.g., feed-forward network sublayer 835). In some cases, each sublayer of decoder 820 is followed by a normalization layer that normalizes a sum computed between a sublayer input x and an output sublayer (x) generated by the sublayer.

In some cases, decoder 820 generates previous output embedding 860 of previous output 855 and adds previous output positional encoding 865 (e.g., position information for words or tokens in previous output 855) to previous output embedding 860. In some cases, each first multi-head self-attention sublayer receives the combination of previous output embedding 860 and previous output positional encoding 865 and applies a multi-head self-attention mechanism to the combination. In some cases, for each word in an input sequence, each first multi-head self-attention sublayer of decoder 820 attends only to words preceding the word in the sequence, and so transformer 800's prediction for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections. The matrix K (key) here is irrelevant to the number of image clusters e.g. as described with reference to FIGS. 7 and 16.

In some cases, each second multi-head self-attention sublayer implements a multi-head self-attention mechanism similar to the multi-head self-attention mechanism implemented in each multi-head self-attention sublayer of encoder 805 by receiving a query matrix Q from a previous sublayer of decoder 820 and a key matrix K and a value V from the output of encoder 805, allowing decoder 820 to attend to each word in the input 840. The key matrix K here is irrelevant to the number of image clusters e.g. as described with reference to FIGS. 7 and 16.

In some cases, each feed-forward network sublayer implements a fully connected feed-forward network similar to feed-forward network sublayer 815. In some cases, the feed-forward network sublayers are followed by a linear transformation and a softmax function to generate a prediction of output 870 (e.g., a prediction of a next word or token in a sequence of words or tokens). Accordingly, in some cases, transformer 800 generates a response as described herein based on a predicted sequence of words or tokens.

FIG. 9 shows an example of a guided diffusion model according to aspects of the present disclosure. The guided latent diffusion model 900 depicted in FIG. 9 is an example of, or includes aspects of, the corresponding element described with reference to FIGS. 6-7 and 16.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 900 may take an original image 905 in a pixel space 910 as input and apply and image encoder 915 to convert original image 905 into original image features 920 in a latent space 925. Then, a forward diffusion process 930 gradually adds noise to the original image features 920 to obtain noisy features 935 (also in latent space 925) at various noise levels.

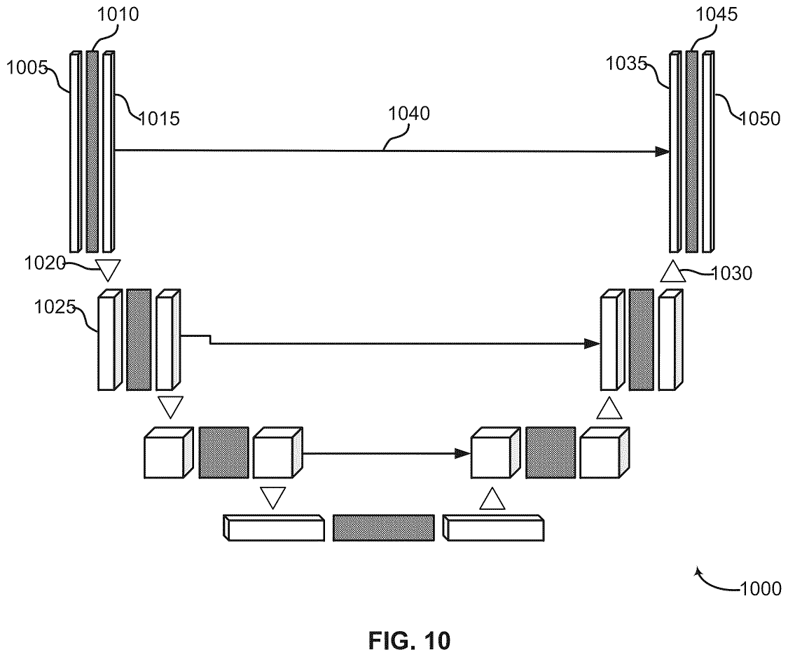

Next, a reverse diffusion process 940 (e.g., a U-Net architecture described in FIG. 10 or a diffusion transformer described with reference to FIG. 12) gradually removes the noise from the noisy features 935 at the various noise levels to obtain denoised image features 945 in latent space 925. In some examples, the denoised image features 945 are compared to the original image features 920 at each of the various noise levels, and parameters of the reverse diffusion process 940 of the diffusion model are updated based on the comparison. Finally, an image decoder 950 decodes the denoised image features 945 to obtain an output image 955 in pixel space 910. In some cases, an output image 955 is created at each of the various noise levels. The output image 955 can be compared to the original image 905 to train the reverse diffusion process 940.

In some cases, image encoder 915 and image decoder 950 are pre-trained prior to training the reverse diffusion process 940. In some examples, image encoder 915 and image decoder 950 are trained jointly, or the image encoder 915 and image decoder 950 and fine-tuned jointly with the reverse diffusion process 940.

The reverse diffusion process 940 can also be guided based on a text prompt 960, or another guidance prompt, such as an image, a layout, a segmentation map, etc. The text prompt 960 can be encoded using a text encoder 965 (e.g., a multimodal encoder) to obtain guidance features 970 in guidance space 975. The guidance features 970 can be combined with the noisy features 935 at one or more layers of the reverse diffusion process 940 to ensure that the output image 955 includes content described by the text prompt 960. For example, guidance features 970 can be combined with the noisy features 935 using a cross-attention block within the reverse diffusion process 940.

FIG. 10 shows an example of a U-Net architecture according to aspects of the present disclosure. In some examples, U-Net 1000 is an example of the component that performs the reverse diffusion process 940 of guided latent diffusion model 900 described with reference to FIG. 9. The U-Net 1000 is an example of, or includes aspects of, the architecture used within the reverse diffusion process described with reference to FIG. 9.

In some examples, diffusion models are based on a neural network architecture known as a U-Net. The U-Net 1000 takes input features 1005 having an initial resolution and an initial number of channels and processes the input features 1005 using an initial neural network layer 1010 (e.g., a convolutional network layer) to produce intermediate features 1015. The intermediate features 1015 are then down-sampled using a down-sampling layer 1020 such that down-sampled features 1025 have a resolution less than the initial resolution and a number of channels greater than the initial number of channels.

This process is repeated multiple times, and then the process is reversed. That is, the down-sampled features 1025 are up-sampled using up-sampling process 1030 to obtain up-sampled features 1035. The up-sampled features 1035 can be combined with intermediate features 1015 having the same resolution and number of channels via a skip connection 1040. These inputs are processed using a final neural network layer 1045 to produce output features 1050. In some cases, the output features 1050 have the same resolution as the initial resolution and the same number of channels as the initial number of channels.

In some cases, U-Net 1000 takes additional input features to produce conditionally generated output. For example, the additional input features could include a vector representation of an input prompt. The additional input features can be combined with the intermediate features 1015 within the neural network at one or more layers. For example, a cross-attention module can be used to combine the additional input features and the intermediate features 1015.

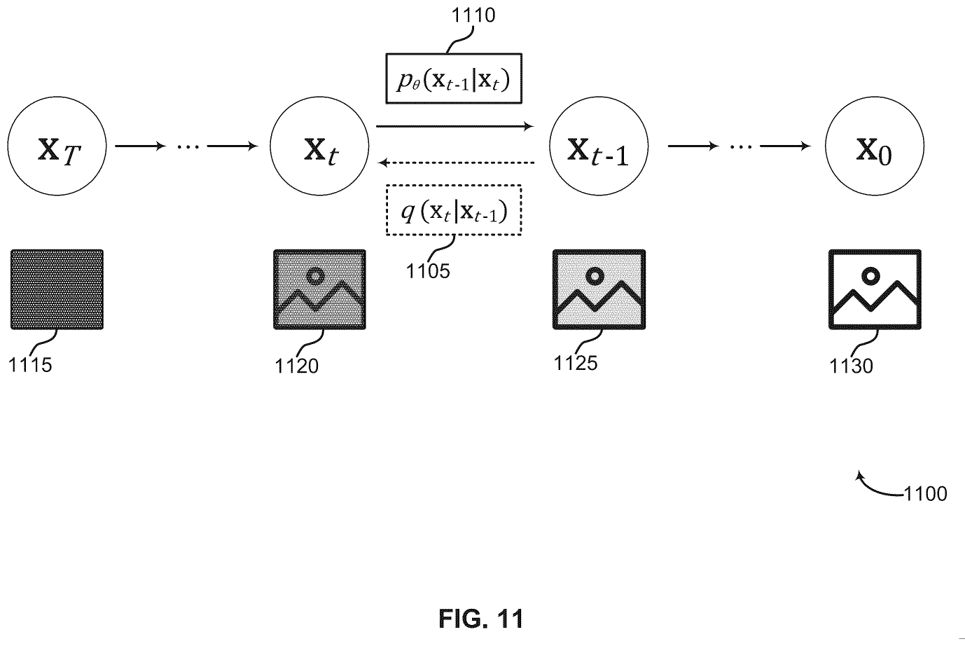

FIG. 11 shows an example of a diffusion process according to aspects of the present disclosure. In some examples, diffusion process 1100 describes an operation of the image processing model as described with reference to FIGS. 6-7 and 16 (e.g. the image generation model contained in the image processing model in FIGS. 7 and 16), such as the reverse diffusion process 940 of guided latent diffusion model 900 described with reference to FIG. 9.

As described above with reference to FIG. 9 and in some examples, with reference to FIG. 10, using a diffusion model can involve both a forward diffusion process 1105 for adding noise to a media item (or features in a latent space) and a reverse diffusion process 1110 for denoising the media item (or features) to obtain a denoised media item. The forward diffusion process 1105 can be represented as q(xₜ|xₜ₋₁), and the reverse diffusion process 1110 can be represented as p_{θ}(x₁₋ₜ|xₜ), where 0 represents some trainable parameters. In some cases, the forward diffusion process 1105 is used during training to generate media items with successively greater noise, and a neural network is trained to perform the reverse diffusion process 1110 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net 1000 as described with reference to FIG. 10, where x₁, . . . , x_{T} have the same dimensionality as x₀.

The neural network may be trained to perform the reverse process. During the reverse diffusion process 1110, the model begins with noisy data x_{T}, such as a noisy media item 1115 and denoises the data to obtain the p(xₜ₋₁|xₜ). At each step t−1, the reverse diffusion process 1110 takes xₜ, such as first intermediate media item 1120, and t as input. Here, t represents a step in the sequence of transitions associated with different noise levels, The reverse diffusion process 1110 outputs xₜ₋₁, such as second intermediate media item 1125 iteratively until x_{T} reverts back to x₀, the original media item 1130. The reverse process can be represented as:

p_{θ}(xₜ₋₁|xₜ):=N(xₜ₋₁;μ_{θ}(xₜ,t),Σ_{θ}(xₜ,t)). (4)

The joint probability of a sequence of samples in the Markov chain can be written as a product of conditionals and the marginal probability:

$${x}_{T} \text{:} {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 5 )$$

where p(x_{T})=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

FIG. 12 shows an example of a diffusion transformer according to aspects of the present disclosure. In the example shown, diffusion transformer 1200 employes an latent diffusion transformer 1294 architecture, including: predicted noise 1205, predicted covariance 1210, linear and reshape layers 1215, normalization layer 1220, DiT block(s) 1225, patchify operation 1230, embedding 1235, noised latent 1240, timestep information 1245, label information 1250.

One embodiment of the DiT block(s) 1225 is DIT block 1296, including: second residual connection 1260, second scaling operations 1262, FFN 1264 ((Pointwise) Feedforward network), post-normalization second scaling and shifting 1266, second normalization 1268, first residual connection 1270, first scaling operations 1272, self-attention 1274, post-normalization first scaling and shifting 1276, first normalization 1278, input tokens 1280, conditioning tokens 1282, MLP 1284 (Multi-layer perceptron), post-normalization first scaling and shifting parameters 1286, first scaling parameter 1288, post-normalization second scaling and shifting parameters 1290, and second scaling parameter 1292.

Diffusion Transformers (DiTs) are a popular architecture for diffusion models and is designed to be structurally faithful to standard transformer architecture. DiT incorporates transformer structures' scaling properties. For training denoising diffusion probabilistic models (DDPMs) of images (e.g. spatial representations of images), DiT is based on a Vision Transformer (ViT) architecture operating on sequences of patches. DiT processes images by dividing them into patches, converting the patches into tokens, and applying attention mechanisms to model relationships between different regions of the image. This allows the model to capture both local and long-range dependencies in the image generation process.

In some cases, input to DiT is a spatial representation z. A first layer of a DiT performs a patchify operation, where the DiT divides an input image into patches and converts the patches (a form of spatial input) into a sequence of T tokens, each of dimension d, by linearly embedding each patch. ViT frequency-based positional embeddings are then applied to all input tokens. In some cases, the number of tokens T generated by patchify is determined by a patch size hyperparameter p, for example T=(I/p)², where I is another shape parameter, thus halving p will quadruple T, which usually at least quadruples total of transformer Giga Floating Point Operations (Gflops). In some examples, parameter counts in downstream layers of DiT is independent from p. Various patch sizes (e.g. p=2,4 or 8) are implemented. In some cases, the DiT network includes a sequence of N DiT blocks, each operating at a hidden dimension size d. Like ViT, the DiT network uses standard transformer configurations that jointly scale N, d and attention heads. Various model sizes (e.g. N=12, 24 or 28) and DiT architectures may be used.

Following Patchify operation, attention mechanisms are applied to model relationships between different regions of the image in one or more DiT blocks. In addition to noised image inputs, diffusion models sometimes process conditional information such as noise timesteps t, class labels c, natural language information, etc. Four variants of DiT blocks are described below.

In some cases, DiT blocks in the DiT network are adaptive layer norm (adaLN) blocks, where following adaptive normalization layers in generative adversarial networks (GANs) and conventional diffusion models with U-Net backbones, standard normalization layers in transformer blocks are replaced with adaLN. Rather than directly learning dimension-wise scale γ and shift parameters β, in adaLN the system regresses γ and β from a sum of the embedding vectors of the noise timesteps t and the class labels c. An adaLN adds relatively small numbers of Gflops and is an efficient conditioning mechanism that applies a same function to all tokens.

In some cases, DiT blocks in the DiT network are adaLN-Zero blocks, which leverages zero-initialization techniques. In Residual Networks (ResNets), initializing each residual block as the identity function x [symbol] x is beneficial. For example, zero-initializing a final batch norm scale factor γ in each block accelerates large-scale training in supervised learning. Diffusion models based on U-Nets may similarly zero-initialize final convolutional layer in each block prior to residual connections. An adaLN-Zero block is modified from an adaLN block using similar zero-initialization. AdaLN-Zero regresses γ, β, and dimension-wise scaling parameters as that are applied immediately prior to residual connections. The network initializes an MLP to output a zero-vector for all as, thus initializing the DiT block as the identity function. AdaLN Zero adds negligible Gflops to the model.

In some cases, DiT blocks in the DiT network adopts in-context conditioning, where embeddings of t and c are appended as additional tokens in the input sequence, and after a final block, the network removes the conditioning tokens. In some cases, DiT blocks in the DiT network include cross-attention blocks: the network concatenates the embeddings of t and c into a length-two sequence, separate from the image token sequence, and the block includes a (multi-head) cross-attention layer following the self-attention block.

After a final DiT block, the DiT network decodes the sequence of image tokens (e.g. using a standard linear decoder) into an output noise prediction and an output diagonal covariance prediction. Both outputs have shapes equal to an original spatial input. A final normalization layer (or adaptive normalization layer if the DiT block is adaLN) is applied, and each token is linearly decoded into a p×p×2C tensor, where C is a number of channels in the spatial input. Decoded tokens are rearranged into their original spatial layout to obtain the predicted noise and covariance.

The DiT architecture, in some embodiments, is a latent diffusion transformer 1294. The DiT architecture processes noised latent 1240, which may be a noised version of an input image encoded in a latent space. Patchify operation 1230 divides the noised latent into a sequence of patches that are processed as tokens. The tokens are vector representations of patches in the latent space. The DiT architecture also receives timestep information 1245 (e.g. the current denoising timestep) and label information 1250 (e.g. class labels) and accordingly performs embedding 1235 of timestep information 1245 and label information 1250. Embedding 1235 is also referred to as conditional embedding or conditional information embedding. In some cases, a positional embedding (e.g. ViT frequency-based positional embedding) to encode each token's spatial position in the image is applied to the patchified input tokens at patchify operation 1230. Input tokens 1280 generated by the patchify operation 1230 and the conditioning tokens 1282 generated by the embedding 1235 are processed through N DIT block(s) 1225.

DiT block 1296 illustrates an embodiment of one block in the DIT block(s) 1225. In some embodiments, the DiT block 1296 is an adaLN-Zero block. In some cases, input tokens 1280 interact with the conditioning tokens 1282 through multiple attention mechanisms. Particularly, after applying first normalization 1278 to the input tokens and MLP 1284 to the conditioning tokens, DiT block 1296 uses MLP 1284 to generate or update post-normalization first scaling and shifting parameters 1286, denoted as γ₁, β₁, for post-normalization first scaling and shifting 1276 to scale and shift the output of first normalization 1278 accordingly. As the normalized input tokens obtained from first normalization 1278 are processed at post-normalization first scaling and shifting 1276 using the conditional information carried as least in γ₁, β₁, this allows the input information and conditional information to interact. Self-attention 1274 (e.g., multi-head self-attention) allows the output from post-normalization first scaling and shifting 1276, to attend to each other. MLP 1284 generates or updates first scaling parameter 1288 denoted as α₁ for first scaling operations 1272 to scale the output of self-attention 1274, further interacting the input and conditional information. Input tokens 1280 is then summed with the output of first scaling operations 1272 at first residual connection 1270. In some cases, α₁ has initial values 0.

A similar process is performed after first residual connection 1270. MLP 1284 generates or updates post-normalization second scaling and shifting parameters 1290, denoted as γ₂, β₂, for post-normalization second scaling and shifting 1266 to scale and shift the output of second normalization 1268 accordingly. FFN 1264 then processes the scaled and shifted output from post-normalization second scaling and shifting 1266. MLP 1284 also generates or updates second scaling parameter 1292 denoted as a₂ for second scaling operations 1262 to scale the output of FFN 1264. In some cases, the FFN 1264 is a pointwise feed-forward network. The output from first residual connection 1270 is then summed with the output of second scaling operations 1262 at second residual connection 1260 to yield an output of DIT block 1296. In some cases, α₂ has initial values 0. This process repeats for each DiT block in the sequence.

After processing through all DiT block(s) 1225, the output undergoes normalization layer 1220 followed by linear and reshape layers 1215. The final output is predicted noise 1205, predicting e.g. the noise initially added to initially create the noised latent 1240, and predicted covariance 1210, representing the model's prediction of the covariance. Predicted noise 1205 is removed from noised latent 1240 at each diffusion timestep, and predicted covariance 1210 may affect how noise is removed or resampled in the reverse or denoising process. After denoising, the latent sample is decoded to generate the synthetic image in pixel space.

In FIGS. 6-12, a method, apparatus, non-transitory computer readable medium, and system for media processing are described. One or more aspects of the method, apparatus, non-transitory computer readable medium, and system include a memory component; and a processing device coupled to the memory component, the processing device configured to perform operations comprising: obtaining an input image and a set of evaluation prompts, wherein the set of evaluation prompts is grouped according to a first group of evaluation prompts and a second group of evaluation prompts; generating a first group-assignment value and a second group-assignment value for the input image corresponding to the first group and the second group, respectively; and generating, using a multi-modal language model, evaluation data for the input image by performing a first group-specific weighted sum based on the first group, a second group-specific weighted sum based on the second group, and a cross-group weighted sum of the first group-specific weighted sum and the second group-specific weighted sum based on the first group-assignment value and the second group-assignment value.

In some aspects, the multi-modal language model comprises an autoregressive transformer model.

In some aspects, the multi-modal language model is configured to take text input and image input.

Some examples of the apparatus, system, and method further include an image generation model configured to generate the input image.

Some examples of the apparatus, system, and method further include a clustering component configured to cluster a set of supporting images to obtain a plurality of image clusters and group the set of evaluation prompts based on the plurality of image clusters to obtain the first group and the second group.

Some examples of the apparatus, system, and method further include a group-assignment component configured to compute the first group-assignment value and the second group-assignment value.

### Calibrating MLLM As a Judge

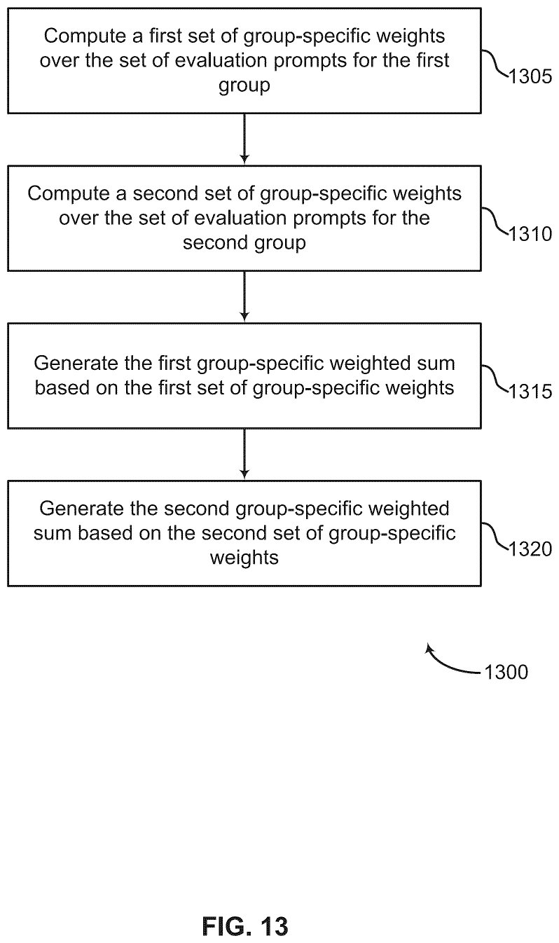

FIG. 13 shows an example of a method 1300 for generating group-specific sums according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1305, the system computes a first set of group-specific weights over the set of evaluation prompts for the first group. In some cases, the operations of this step refer to, or may be performed by, an image processing model as described with reference to FIGS. 6-7, and 16. For example, first set of group-specific weights can refer to

$${\{ {w}_{2 , {a}_{i}}^{*} \}}_{{a}_{i} ∈ a}$$

at inference (referring to FIG. 7) or {w_{1,a}_{ᵢ}}ₐ_{ᵢ}_{∈a} (referring to FIG. 16)) at training.

At operation 1310, the system computes a second set of group-specific weights over the set of evaluation prompts for the second group. In some cases, the operations of this step refer to, or may be performed by, an image processing model as described with reference to FIGS. 6-7, and 16. For example, second set of group-specific weights can refer to

$${\{ {w}_{1 , {a}_{i}}^{*} \}}_{{a}_{i} ∈ a}$$

at inference (referring to FIG. 7) or {w_{2,a}_{ᵢ}}ₐ_{ᵢ}_{∈a} (referring to FIG. 16) at training.

At operation 1315, the system generates the first group-specific weighted sum based on the first set of group-specific weights. In some cases, the operations of this step refer to, or may be performed by, an image processing model as described with reference to FIGS. 6-7, and 16. In some embodiments, the first group-specific weighted sum is further based on prompt-specific evaluation data for the input image. For example, referring to FIG. 7, first group-specific weighted sum is

$${\sum }_{a ∈ a} ( {w}_{1 a}^{*} \cdot p ( y \vert x , a ) ) ,$$

where for each evaluation prompt a∈a,

$${w}_{1 a}^{*}$$

is a learned group-specific weight corresponding to the first group and the evaluation prompt a, and p(y|x, a) is evaluation data specific to the evaluation prompt a for x.

At operation 1320, the system generates the second group-specific weighted sum based on the second set of group-specific weights. In some cases, the operations of this step refer to, or may be performed by, an image processing model as described with reference to FIGS. 6-7 and 16. For example, referring to FIG. 7, second group-specific weighted sum is

$${\sum }_{a ∈ a} ( {w}_{2 a}^{*} \cdot p ( y \vert x , a ) ) ,$$

with quantities denoted or defined analogously to those described for operation 1315.

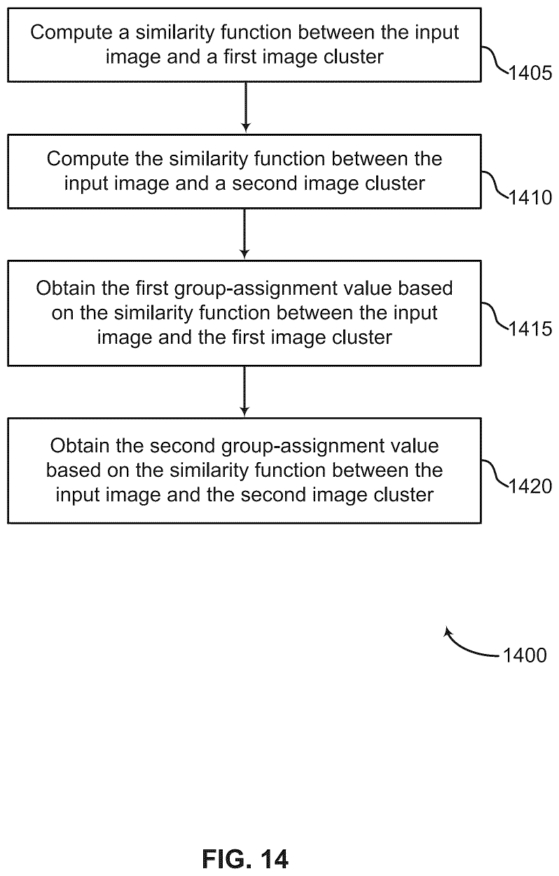

FIG. 14 shows an example of a method 1400 for obtaining group-assignment values according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1405, the system computes a similarity function between the input image and the first image cluster. In some cases, the operations of this step refer to, or may be performed by, a group-assignment component as described with reference to FIG. 6. Examples of a first image cluster, for example, “graphic design images,” are described with reference to FIGS. 1-2, 4 and 15. In some embodiments, the system evaluates a similarity between an image embedding of the input image and the first image cluster. More details are described with reference to FIG. 7.

At operation 1410, the system computes the similarity function between the input image and the second image cluster. In some cases, the operations of this step refer to, or may be performed by, a group-assignment component as described with reference to FIG. 6. Examples of a second image cluster, for example, “landscape photos,” are described with reference to FIGS. 1-2, 4 and 15. In some embodiments, the system evaluates a similarity between an image embedding of the input image and the second image cluster. More details are described with reference to FIG. 7.

At operation 1415, the system obtains the first group-assignment value based on the similarity function between the input image and the first image cluster. In some cases, the operations of this step refer to, or may be performed by, a group-assignment component as described with reference to FIG. 6. In some cases, the first group-assignment value indicates a probability of assigning the input image to the first image cluster. More details are described with reference to FIG. 7.

At operation 1420, the system obtains the second group-assignment value based on the similarity function the input image and the second image cluster. In some cases, the operations of this step refer to, or may be performed by, a group-assignment component as described with reference to FIG. 6. In some cases, the second group-assignment value indicates a probability of assigning the input image to the second image cluster. More details are described with reference to FIG. 7.

FIG. 15 shows an example of a multi-modal image evaluation system 1500 according to aspects of the present disclosure. The example shown includes multi-modal image evaluation system 1500, input image 1505, ground-truth evaluation 1510, first image cluster 1515, second image cluster 1520, first set of intermediate evaluations 1525, second set of intermediate evaluations 1530, first similarity value 1535, second similarity value 1540, evaluation data generation 1545, and predicted evaluation 1550.

At inference, ground-truth evaluation 1510 is not provided, input image 1505 is contained in a test set, weights are frozen, and multi-modal image evaluation system 1500 tries to generate using image processing model 700 (as described with reference to FIG. 7) predicted evaluation 1550 for input image 1505; at training, ground-truth evaluation 1510 corresponding to input image 1505 is provided, input image 1505 is contained in a validation set (or a training set in some examples) typically disjoint from the test set, and multi-modal image evaluation system 1500 tries to train group-specific weights of image processing model 1600 (referring to FIG. 16) by optimizing a machine-learning objective (e.g. machine learning objective 1670) as described with reference to FIG. 16.

Input image 1505 is an example of, or includes aspects of, the corresponding element described with reference to FIGS. 1-2, and FIG. 7 or 16. In the example shown, input image 1505 is a graphic-design style image depicting a crowded street view. Ground-truth evaluation 1510 (provided at training) indicates a positive evaluation of input image 1505.

First image cluster 1515 and second image cluster 1520 are examples of, or include aspects of, image clusters as described with reference to FIGS. 1-4, and FIG. 7 or 16. Before inference (and in some embodiments also before training), first image cluster 1515 and second image cluster 1520 are obtained by clustering a set of supporting images Dₛᵤₚ (generated by image generation model 1610 or 710) using clustering component 640 (as described with reference to FIG. 6).

First set of intermediate evaluations 1525 and second set of intermediate evaluations 1530 are examples of or includes aspects of FIG. 2, and FIG. 7 or 16. At training, the example shown reflects that

$${w}_{1 a} \cdot p ( {y}_{j}^{*} \vert , {x}_{j} , {a}_{1} ) < {w}_{1 {a}_{3}} \cdot p ( {y}_{j}^{*} \vert , {x}_{j} , {a}_{3} ) < {w}_{1 {a}_{2}} \cdot p ( {y}_{j}^{*} \vert , {x}_{j} , {a}_{2} )$$

$$and$$

$${w}_{2 {a}_{2}} \cdot p ( {y}_{j}^{*} \vert , {x}_{j} , {a}_{2} ) \approx {w}_{2 {a}_{3}} \cdot p ( {y}_{j}^{*} \vert , {x}_{j} , {a}_{3} ) < {w}_{2 {a}_{1}} \cdot p ( {y}_{j}^{*} \vert , {x}_{j} , {a}_{1} )$$

(referring to FIG. 16 for notations), where the w_{za}_{ᵢ}s are being trained; at inference, the example shown reflects that

$${w}_{1 {a}_{1}}^{*} \cdot p ( y \vert x , {a}_{1} ) < {w}_{1 {a}_{3}}^{*} \cdot p ( y \vert x , {a}_{3} ) < {w}_{1 {a}_{2}}^{*} \cdot p ( y \vert x , {a}_{2} )$$

$$and$$

$${w}_{2 {a}_{2}}^{*} \cdot p ( y \vert x , {a}_{2} ) \approx {w}_{2 {a}_{3}}^{*} \cdot p ( y \vert x , {a}_{3} ) < {w}_{2 {a}_{1}}^{*} \cdot p ( y \vert x , {a}_{1} )$$

(referring to FIG. 7 for notations), where weights

$${w}_{{za}_{i}}^{*} s$$

are frozen. Accordingly, in the example shown, Prompt B is a best-performing prompt for a first group (corresponding to the first image cluster 1515), and Prompt A is a best-performing prompt for a second group (corresponding to the second image cluster 1520), where a₁, a₂ and a₃ respectively correspond to Prompt A, Prompt B, and Prompt C. First set of intermediate evaluations 1525 includes quantities used to compute a first group-specific weighted sum (e.g. referring to FIG. 7), and second set of intermediate evaluations 1530 includes quantities used to compute a second group-specific weighted sum (e.g. referring to FIG. 7).

First similarity value 1535 and second similarity value 1540 are examples of, or include aspects of, the corresponding element in FIG. 7 or 16. At inference (e.g. referring to FIG. 7), first similarity value 1535 and second similarity value 1540 are used to further weight a corresponding group-specific weighted sum, forming summands for evaluation data generation 1545 to compute a cross-group weighted sum. At training (e.g. referring to FIG. 16), first similarity value 1535 and second similarity value 1540 are soft-group assignments as ingredients for the machine-learning objective (e.g. machine learning objective 1670) that is used to train group-specific weights.

Evaluation data generation 1545 is an example of, or includes aspects of, the corresponding element described with reference to FIG. 7. At inference, evaluation data generation 1545 generates predicted evaluation 1550 for input image 1505; in the example shown, the predicted evaluation 1550 indicates a positive evaluation for input image 1505.

In FIGS. 13-15, a method, apparatus, non-transitory computer readable medium, and system for media processing are described. One or more aspects of the method, apparatus, non-transitory computer readable medium, and system include obtaining an input image and a set of evaluation prompts grouped in a plurality of groups; computing, using a multi-modal language model, a group-specific weighted sum of outputs of the multi-modal language model based on the set of evaluation prompts to obtain group-specific sum result; and generating evaluation data for the input image by performing a cross-group weighted sum based on the group-specific sum result.

In some examples of the method, apparatus, non-transitory computer readable medium, and system, performing the cross-group weighted sum includes determining a group-assignment value for each of the plurality of groups, wherein the cross-group weighted sum is based on the group-assignment value.

In some examples of the method, apparatus, non-transitory computer readable medium, and system, determining the group-assignment value includes computing a similarity function based on the input image, wherein the group-assignment value is based on the similarity function.

In some examples of the method, apparatus, non-transitory computer readable medium, and system, computing the group-specific weighted sum includes generating, using the multi-modal language model, prompt-specific evaluation data for the input image corresponding to each of the set of evaluation prompts. In some examples, computing the group-specific weighted sum further includes weighting the prompt-specific evaluation data for each of the set of evaluation prompts based on a set of group-specific weights corresponding to each of the plurality of groups.

In some aspects, the set of group-specific weights corresponding to each of the plurality of groups is trained by optimizing a machine-learning objective using ground-truth evaluation data.

Some examples of the method, apparatus, non-transitory computer readable medium, and system further include clustering a set of supporting images to obtain a plurality of image clusters and group the set of evaluation prompts based on the plurality of image clusters to obtain the first group and the second group.

In some examples of the method, apparatus, non-transitory computer readable medium, and system, obtaining the input image includes generating the input image using an image generation model.

### Training

FIG. 16 shows an example of a procedure for training an image processing model 1600 according to aspects of the present disclosure. The example shown includes image processing model 1600, set of evaluation prompts 1605, image generation model 1610, input image 1615, input image with ground-truth evaluation 1620, multi-modal language model 1625, similarity function 1630, group-assignment values 1635, prompt-specific evaluation data 1640, sets of group-specific prompt-specific evaluation data 1645, optimizer 1660, group-specific weights 1665, and machine learning objective 1670.

Before training, image generation model 1610 (identical to, includes aspects of, or is an example of image generation model 710) has generated a test set of images for later usage in inference (referring to FIG. 7; the test set is depicted herein for consistency, not used for training). Before training, image generation model 1610 has generated validation set Dᵥₐₗ containing input image 1615 (denoted as xⱼ) that is unlabeled and a set of supporting images Dₛᵤₚ, and clustering component 640 (as described with reference to FIG. 6) has partitioned Dₛᵤₚ into K groups g₁, . . . , g_{K} (K≥2). Before training, validation set Dᵥₐₗ is passed to Human Annotation where for each xⱼ∈Dᵥₐₗ, a corresponding group-truth value (e.g. a label or a numerical value, indicating e.g. preference or an evaluation score)

$${y}_{j}^{*}$$

is attached. This gives rise to input image with ground-truth evaluation 1620

$$( {x}_{j} , {y}_{j}^{*} ) .$$

In some embodiments, Dᵥₐₗ (and annotated validation set

$${D}_{val}^{*} )$$

Includes a finite number of images (respectively labelled or annotated images); as such,

$${D}_{val}^{*}$$

can be denoted as

$${\{ ( {x}_{j} , {y}_{j}^{*} ) \}}_{j = 1}^{M} .$$

In FIG. 16, image processing model 1600 is at training stage, where image generation model 1610 and multi-modal language model 1625 are frozen. Multi-modal language model 1625 obtains set of evaluation prompts 1605 (a), for example from database 120 (referring to FIGS. 1-2), and obtains input image with ground-truth evaluation 1620

$$( {x}_{j} , {y}_{j}^{*} )$$

from the annotated validation set

$${D}_{val}^{*} .$$

Multi-modal language model 1625 generates prompt-specific evaluation data 1640

$$( p ( {y}_{j}^{*} \vert {x}_{j} , {a}_{j} )$$

for each aᵢ∈a).

On the other hand, group-assignment component 645 (referring to FIG. 6) computes a similarity function 1630 (sim(φ_{I}(xⱼ), g_{z}) for each z∈{1, . . . , K}) based on the input image 1615, and generates group-assignment values 1635 (p(z|xⱼ) for each z∈{1, . . . , K}) based on similarity function 1630. Prompt-specific evaluation data 1640 and group-assignment values 1635 are collected into sets of group-specific prompt-specific evaluation data 1645 for processing via optimizer 1660.

Sets of group-specific prompt-specific evaluation data 1645 includes first set of group-specific prompt-specific evaluation data 1650 and second set of group-specific prompt-specific evaluation data 1655, and sets of group-specific prompt-specific evaluation data respectively corresponding to other groups g_{z} (z∈{3, . . . , K}) in cases where K>2. In some embodiments, first set of group-specific prompt-specific evaluation data 1650 includes data

$$( {\{ p ( {y}_{j}^{*} \vert {x}_{j} , {a}_{j} ) \}}_{{a}_{i} ∈ a} , p ( 1 \vert {x}_{j} ) ) ,$$

second set of group-specific prompt-specific evaluation data 1655 includes data

$$( {\{ p ( {y}_{j}^{*} \vert {x}_{j} , {a}_{j} ) \}}_{{a}_{i} ∈ a} , p ( 2 \vert {x}_{j} ) ) , etc .$$

Optimizer 1660, taking and using sets of group-specific prompt-specific evaluation data 1645, trains group-specific weights 1665 ({w_{za}}_{a∈a} for each z∈{1, . . . , K}) by optimizing machine learning objective 1670. In some embodiments, machine learning objective 1670 is to obtain group-specific weights 1665 that maximizes following quantity:

$${\sum }_{j = 1}^{M} {\sum }_{z = 1}^{K} p ( z \vert {x}_{j} ) [ {\sum }_{a} {w}_{za} log p ( {y}_{j}^{*} \vert {x}_{j} , a ) - {\sum }_{a} {w}_{za} log {w}_{za} ] \qquad ( 6 )$$

where a ranges over set of evaluation prompts 705 (a), each term p(z|xⱼ) is a soft group assignment,

$${\sum }_{a} {w}_{za} log p ( {y}_{j}^{*} \vert {x}_{j} , a )$$

is or represents a per-group likelihood, and Σₐ w_{za} log w_{za} is a per-group entropy regularizer. In some cases, optimization of machine learning objective 1670 is achieved by maximizing entropy

$$( corresponding to {\sum }_{j = 1}^{M} {\sum }_{z = 1}^{K} p ( z \vert {x}_{j} ) [ - {\sum }_{a} {w}_{za} log {w}_{za} ] )$$

and minimizing negative log-likelihood

$$( “ NLL ” , corresponding to$$

$$- 1 \cdot ( {\sum }_{j = 1}^{M} {\sum }_{z = 1}^{K} p ( z \vert {x}_{j} ) [ {\sum }_{a} {w}_{za} log p ( {y}_{j}^{*} \vert {x}_{j} , a ) ] ) ) .$$

In some embodiments, optimizer 1660 implements other optimization algorithms or methods to optimize machine learning objective 1670.

Image processing model 1600 is an example of, or includes aspects of, the corresponding element described with reference to FIGS. 6-7. In some embodiments, image processing model 700 refers to, is an example of, or includes aspects of image processing model 1600 after training. Set of evaluation prompts 1605 (a) is an example of, or includes aspects of, the corresponding element described with reference to FIG. 7. Image generation model 1610 is an example of, or includes aspects of, the corresponding element described with reference to FIGS. 6-7.

Input image 1615 includes aspects of the corresponding element described with reference to FIGS. 7 and 15. Input image 715 (x) (referring to FIG. 7 where image processing model 700 is at inference) is contained in the test set of images while input image 1615 (xⱼ) is contained in a validation set of images; the test set and the validation set are typically disjoint.

Multi-modal language model 1625 is an example of, or includes aspects of, the corresponding element described with reference to FIGS. 6-7. Similarity function 1630 is an example of, or includes aspects of, the corresponding element described with reference to FIG. 7. Group-assignment values 1635 is an example of, or includes aspects of, the corresponding element described with reference to FIG. 7. Prompt-specific evaluation data 1640 is an example of, or includes aspects of, the corresponding element described with reference to FIG. 7. At training, prompt-specific evaluation data 1640, similarity function 1630 and group-assignment values 1635 are evaluated or generated for input image 1615 (xⱼ∈Dᵥₐₗ).

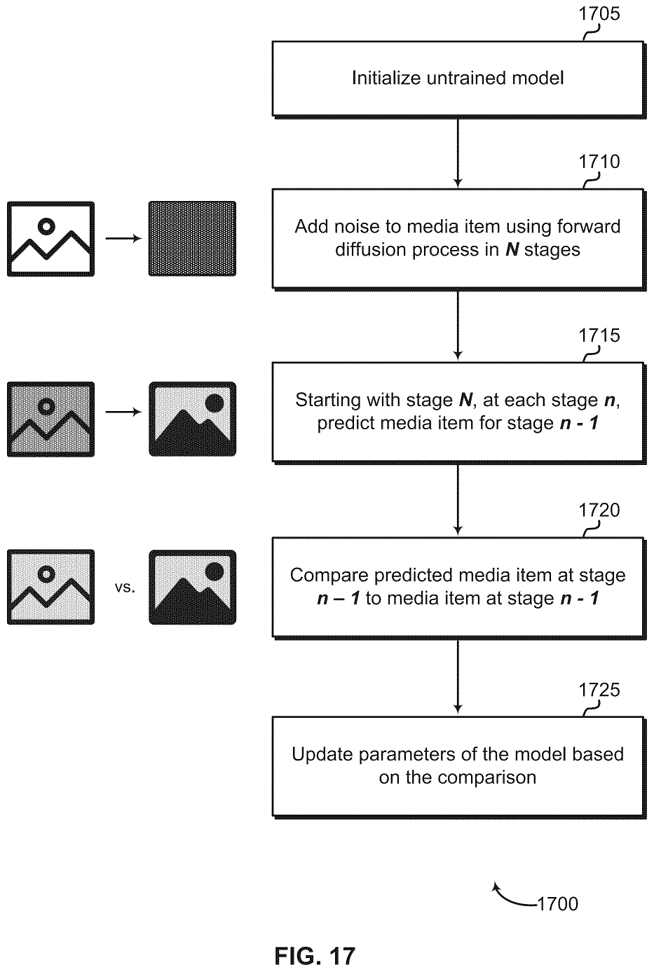

FIG. 17 shows an example of a procedure or method for training a diffusion model according to aspects of the present disclosure. In some embodiments, the method 1700 describes an operation of the training component 650 described for configuring the image processing model 625 as described with reference to FIG. 6. The method 1700 represents an example for training a reverse diffusion process 940 as described above with reference to FIG. 9. In some examples, these operations are performed by a system including a processor executing a set of codes to control functional elements of an apparatus.

Additionally or alternatively, certain processes of method 1700 may be performed using special-purpose hardware. Generally, these operations are performed according to the methods and processes described in accordance with aspects of the present disclosure. In some cases, the operations described herein are composed of various substeps or are performed in conjunction with other operations.

At operation 1705, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1710, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1715, starting with stage N, at each stage n, the system runs a reverse diffusion process to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1720, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ} (x) of the training data.

At operation 1725, the system updates parameters of the model based on the comparison. For example, parameters of a diffusion transformer (as described with reference to FIG. 12) may be updated using gradient descent. Time-dependent parameters of the Gaussian transitions can also be learned.

FIG. 18 shows an example of a procedure for training a machine learning model according to aspects of the present disclosure. In some embodiments, the procedure 1800 describes an operation of the training component 650 described for configuring the image processing model 625 as described with reference to FIG. 6. The procedure 1800 provides one or more examples of generating training data, use of the training data to train a machine learning model, and use of the trained machine learning model to perform a task.

To begin in this example, a machine-learning system collects training data (block 1802) to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1804) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1806). Initialization of the machine-learning model includes selecting a model architecture (block 1808) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1810). The loss function is utilized to measure a difference between an output of the machine-learning model (i.e., predictions) and target values (e.g., as expressed by the training data) to be used to train the machine-learning model. Additionally, an optimization algorithm is selected (block 1812) to be used in conjunction with the loss function to optimize parameters of the machine-learning model during training, examples of which include gradient descent, stochastic gradient descent (SGD), and so forth.

Initialization of the machine-learning model further includes setting hyperparameters (block 1814) and setting initial values (block 1816) of the machine-learning model, examples of which includes initializing weights and biases of nodes to increase efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1818) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a set of nodes that collectively form a set of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1820), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1820), the procedure 1800 continues training of the machine-learning model using the training data (block 1818) in this example.

If the stopping criterion is met (“yes” from decision block 1820), the trained machine-learning model is then utilized to generate an output based on subsequent data (block 1822). The trained machine-learning model, for instance, is trained to perform a task as described above and therefore, once trained is configured to perform that task based on subsequent data received as an input and processed by the machine-learning model.

FIG. 19 shows an example of a computing device for image processing according to aspects of the present disclosure. The computing device 1900 may be an example of the image processing apparatus 600 described with reference to FIG. 6. In one aspect, computing device 1900 includes one or more processors 1905, memory subsystem 1910, communication interface 1915, I/O interface 1920, user interface component(s) 1925, and channel 1930.

In some embodiments, computing device 1900 is an example of, or includes aspects of, the image generation model of FIG. 6. In some embodiments, computing device 1900 includes one or more processors 1905 that can execute instructions stored in memory subsystem 1910 to perform media generation.

According to some aspects, computing device 1900 includes one or more processors 1905. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1915 operates at a boundary between communicating entities (such as computing device 1900, one or more user devices, a cloud, and one or more databases) and channel 1930 and can record and process communications. In some cases, communication interface 1915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1920 is controlled by an I/O controller to manage input and output signals for computing device 1900. In some cases, I/O interface 1920 manages peripherals not integrated into computing device 1900. In some cases, I/O interface 1920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1920 or via hardware components controlled by the I/O controller.

According to some aspects, user interface component(s) 1925 enable a user to interact with computing device 1900. In some cases, user interface component(s) 1925 include an audio device, such as an external speaker system, an external display device such as a display screen, an input device (e.g., a remote-control device interfaced with a user interface directly or through the I/O controller), or a combination thereof. In some cases, user interface component(s) 1925 include a GUI.

Performance of apparatus, systems and methods of the present disclosure have been evaluated, and results indicate embodiments of the present disclosure have obtained increased performance over conventional technology. Example experiments demonstrate that the image processing apparatus and the image processing model described in embodiments of the present disclosure outperforms conventional systems.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image processing, comprising:
obtaining an input image and a set of evaluation prompts, wherein the set of evaluation prompts is grouped according to a first group and a second group;
generating a group-assignment value for the input image corresponding to each of the first group and the second group; and
generating, using a multi-modal language model, evaluation data for the input image by performing a group-specific weighted sum and a cross-group weighted sum based on the group-assignment value.

2. The method of claim 1, wherein generating the evaluation data comprises:
performing a first group-specific weighted sum based on the first group, a second group-specific weighted sum based on the second group, and a cross-group weighted sum of the first group-specific weighted sum and the second group-specific weighted sum.

3. The method of claim 1, further comprising:
clustering a set of evaluation prompts supporting images to obtain a plurality of image clusters; and
grouping the set of evaluation prompts based on the plurality of image clusters to obtain the first group and the second group.

4. The method of claim 1, further comprising:
computing a first set of group-specific weights over the set of evaluation prompts for the first group and a second set of group-specific weights over the set of evaluation prompts for the second group, wherein a first group-specific weighted sum is based on the first set of group-specific weights and a second group-specific weighted sum is based on the second set of group-specific weights.

5. The method of claim 4, wherein:
the first set of group-specific weights and the second set of group-specific weights are trained by optimizing a machine-learning objective using ground-truth evaluation data.

6. The method of claim 1, wherein generating the group-assignment value comprises:
computing a similarity function based on the input image to obtain a first group-assignment value and a second group-assignment value.

7. The method of claim 1, wherein generating the evaluation data comprises:
generating, using the multi-modal language model, prompt-specific evaluation data for the input image corresponding to each of the set of evaluation prompts, wherein a first group-specific weighted sum and a second group-specific weighted sum are based on the prompt-specific evaluation data.

8. A non-transitory computer readable medium storing code for image processing, the code comprising instructions that, when executed by at least one processor, cause the at least one processor to perform operations comprising:
obtaining an input image and a set of evaluation prompts;
computing, using a multi-modal language model, a group-specific weighted sum of outputs of the multi-modal language model based on the set of evaluation prompts to obtain a group-specific sum result; and
generating evaluation data for the input image by performing a cross-group weighted sum based on the group-specific sum result.

9. The non-transitory computer readable medium of claim 8, wherein performing the cross-group weighted sum comprises:
determining a group-assignment value for each of a plurality of groups, wherein the cross-group weighted sum is based on the group-assignment value.

10. The non-transitory computer readable medium of claim 9, wherein determining the group-assignment value comprises:
computing a similarity function based on the input image, wherein the group-assignment value is based on the similarity function.

11. The non-transitory computer readable medium of claim 8, wherein computing the group-specific weighted sum comprises:
generating, using the multi-modal language model, prompt-specific evaluation data for the input image corresponding to each of the set of evaluation prompts; and
weighting the prompt-specific evaluation data for each of the set of evaluation prompts based on a set of group-specific weights corresponding to each of a plurality of groups.

12. The non-transitory computer readable medium of claim 11, wherein:
the set of group-specific weights corresponding to each of a plurality of groups is trained by optimizing a machine-learning objective using ground-truth evaluation data.

13. The non-transitory computer readable medium of claim 8, the code further comprising instructions executable by the at least one processor to perform operations comprising:
clustering a set of supporting images to obtain a plurality of image clusters; and
grouping the set of evaluation prompts based on the plurality of image clusters to obtain a plurality of groups.

14. The non-transitory computer readable medium of claim 8, wherein obtaining the input image comprises:
generating the input image using an image generation model.

15. A system for image processing, comprising:
a memory component; and
a processing device coupled to the memory component, the processing device configured to perform operations comprising:
obtaining an input image and a set of evaluation prompts, wherein the set of evaluation prompts is grouped according to a first group and a second group;
generating a group-assignment value for the input image corresponding to each of the first group and the second group; and
generating, using a multi-modal language model, evaluation data for the input image by performing a group-specific weighted sum and a cross-group weighted sum based on the group-assignment value.

16. The system of claim 15, wherein:
the multi-modal language model comprises an autoregressive transformer model.

17. The system of claim 15, wherein:
the multi-modal language model is configured to take text input and image input.

18. The system of claim 15, further comprising:
an image generation model configured to generate the input image.

19. The system of claim 15, further comprising:
a clustering component configured to cluster a set of supporting images to obtain a plurality of image clusters and group the set of evaluation prompts based on the plurality of image clusters to obtain the first group and the second group.

20. The system of claim 15, further comprising:
a group-assignment component configured to compute the group-assignment value.
